(19) United States
(12) Patent Application Publication
(10) Pub. No.: US 2025/0125895 A1
(43) Pub. Date: Apr. 17, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Wendong LIU, Dongguan (CN); Zhihua SHI, Dongguan (CN)

(21) Appl. No.: 18/990,277

(22) Filed: Dec. 20, 2024

Related U.S. Application Data
(63) Continuation of application No. PCT/CN2022/111760, filed on Aug. 11, 2022.

(51) Int. Cl. H04B 17/391; H04B 17/26; H04B 17/318; H04B 17/373

(52) U.S. Cl. CPC H04B 17/3913; H04B 17/26; H04B 17/318; H04B 17/373

(57) ABSTRACT

A wireless communication method, a terminal device, and a network device are provided. The method includes: performances of M historical signals are obtained by detecting the M historical signals; and on the basis of, performances of N target signals and/or K target signals having performance meeting a preset condition in the N target signals are predicted based on the performances of the M historical signals using a target prediction model. M and N are both positive integers, and K is less than or equal to N.

### CROSS-REFERENCE TO RELATED APPLICATION

This is a continuation application of International Application No. PCT/CN2022/111760, filed on Aug. 11, 2022. The disclosure of the above application is hereby incorporated by reference in its entirety.

### BACKGROUND

In the related art, in a Beam failure recovery (BFR) process, a terminal device determines a Beam Failure Event by measuring the performance of Beam Failure Detection Reference Signal (BFD RS), and discovers a new beam by measuring the performance of New Beam Identification Reference Signal (NBI RS). However, the configurations of the BFD RS and the NBI RS inevitably cause additional signaling overhead, which in turn leads to excessive cost of the BFR process. In addition, since the BFD RS and the NBI RS are periodic reference signals, the periodicity thereof causes the measurements for the performances of the BFD RS and the NBI RS to be periodic, thereby increasing the delay of the BFR.

### SUMMARY

Embodiments of the present disclosure relate to the field of communication, and more specifically, to a wireless communication method, a terminal device, and a network device. Embodiments of the present disclosure provide a wireless communication method, a terminal device, and a network device, which reduce signaling overhead and delay caused when obtaining performances of N target signals and/or obtaining K target signals whose performances satisfy a prediction condition among N target signals.

In the first aspect, embodiments of the present disclosure provide a wireless communication method. The method includes the following operations.

Performances of M historical signals are obtained by detecting the M historical signals.

Based on the performances of the M historical signals, performances of N target signals, and/or K target signals whose performances satisfy a preset condition among the N target signals are predicted by using a target prediction model.

M and N are both positive integers, and K≤N.

In the second aspect, embodiments of the present disclosure provide a wireless communication method. The method includes the following operation.

A Beam Failure Recovery request, BFRQ, transmitted by a terminal device is received.

The BFRQ includes identifications of K target signals and information indicating time units at which Beam Failure Events occur corresponding to the K target signals.

In the third aspect, embodiments of the present disclosure provide a wireless communication method. The method includes the following operations.

Performances of M historical signals transmitted by a terminal device are received.

Based on the performances of the M historical signals, performances of N target signals, and/or K target signals whose performances satisfy a preset condition among the N target signals are predicted by using a target prediction model.

M and N are both positive integers, and K≤N.

In the fourth aspect, embodiments of the present disclosure provide a wireless communication method. The method includes the following operation.

Indication information transmitted by a network device is received.

The indication information includes identifications of K target signals and information indicating time units at which Beam Failure Events occur corresponding to the K target signals.

In the fifth aspect, the present disclosure provides a terminal device for performing the methods of the above first aspect, fourth aspect, or implementations thereof. Specifically, the terminal device includes functional module for performing the method of the above first aspect, fourth aspect, or implementations thereof.

In one implementation, the terminal device may include a processing unit. The processing unit is configured to perform a function related to information processing. For example, the processing unit may be a processor.

In one implementation, the terminal device may include a transmitting unit and/or a receiving unit. The transmitting unit is configured to perform a function related to transmitting, and the receiving unit is configured to perform a function related to reception. For example, the transmitting unit may be a transmitter or a sender, and the receiving unit may be a receiver or a receiving machine. For another example, the terminal device is a communication chip, the receiving unit may be an input circuit or an interface of the communication chip, and the transmitting unit may be an output circuit or an interface of the communication chip.

In the sixth aspect, the present disclosure provides a network device for performing the method of the above second aspect, third aspect, or implementations thereof. Specifically, the network device includes functional module for performing the method of the above second aspect, third aspect, or implementations thereof.

In one implementation, the network device may include a processing unit. The processing unit is configured to perform a function related to information processing. For example, the processing unit may be a processor.

In one implementation, the network device may include a transmitting unit and/or a receiving unit. The transmitting unit is configured to perform a function related to transmitting, and the receiving unit is configured to perform a function related to reception. For example, the transmitting unit may be a transmitter or a sender, and the receiving unit may be a receiver or a receiving machine. For another example, the network device is a communication chip, the receiving unit may be an input circuit or an interface of the communication chip, and the transmitting unit may be an output circuit or an interface of the communication chip.

In the seventh aspect, embodiments of the present disclosure provide a terminal device including a transceiver, a processor, and a memory. The memory is configured to store a computer program, and the processor is configured to invoke and run the computer program stored in the memory to cause the processor and the transceiver to perform the method of the above first aspect, fourth aspect, or implementations thereof.

In one implementation, the number of the processors is one or more, and the number of memories is one or more.

In one implementation, the memory may be integrated with the processor, or the memory may be provided separately from the processor.

In one implementation, the transceiver includes a transmitter (sender) and a receiver (receiving machine).

In the eighth aspect, the present disclosure provides a network device including a transceiver, a processor, and a memory. The memory is configured to store a computer program, and the processor is configured to invoke and run the computer program stored in the memory to cause the processor and the transceiver to perform the method of the above second aspect, third aspect, or implementations thereof.

In one implementation, the number of the processors is one or more, and the number of memories is one or more.

In one implementation, the memory may be integrated with the processor, or the memory may be provided separately from the processor.

In one implementation, the transceiver includes a transmitter (sender) and a receiver (receiving machine).

In the ninth aspect, the present disclosure provides a chip for implementing the method of any one of the above first to fourth aspects or implementations thereof. Specifically, the chip includes a processor for invoking and running a computer program from a memory to cause a device on which the chip is mounted to perform a method of any one of the above first to fourth aspects or implementations thereof.

In the tenth aspect, the present disclosure provides a computer readable storage medium for storing a computer program. The computer program causes a computer to perform a method of any one of the above first to fourth aspects or implementations thereof.

In the eleventh aspect, the present disclosure provides a computer program product including computer program instructions. The computer program instructions cause a computer to perform a method of any one of the above first to fourth aspects or implementations thereof.

In the twelfth aspect, the present disclosure provides a computer program. When the computer program is run on a computer, the computer performs a method of any one of the above first to fourth aspects or implementations thereof.

### BRIEF DESCRIPTION OF THE DRAWINGS

FIG. 1 is a schematic diagram of a communication system architecture provided by an embodiment of the present disclosure.

FIG. 2 is a schematic diagram of a neuron structure provided by an embodiment of the present disclosure.

FIG. 3 is an example of a structure of a Neural Network (NN) provided by an embodiment of the present disclosure.

FIG. 4 is a schematic diagram of a Convolutional Neural Network (CNN) provided by an embodiment of the present disclosure.

FIG. 5 is a schematic diagram of a Long Short-Term Memory (LSTM) unit provided by an embodiment of the present disclosure.

FIG. 6 is a schematic diagram of training and inferring K optimal signals and performances of K optimal signals by using two independent prediction models provided by an embodiment of the present disclosure.

FIG. 7 is a schematic diagram of an input-output relationship of a prediction model 1 provided by an embodiment of the present disclosure.

FIG. 8 is a schematic diagram of an input-output relationship of a prediction model 2 provided by an embodiment of the present disclosure.

FIG. 9 is a schematic flowchart of a BFR process provided by an embodiment of the present disclosure.

FIG. 10 is a schematic flowchart of a wireless communication method provided by an embodiment of the present disclosure.

FIG. 11 is a schematic diagram of a relationship between historical signals and target signals provided by an embodiment of the present disclosure.

FIG. 12 is a schematic diagram of a structure of a target prediction model capable of performing signal prediction or signal performance prediction in a spatial domain provided by an embodiment of the present disclosure.

FIG. 13 is a schematic diagram of performing signal prediction or signal performance prediction in a temporal domain provided by an embodiment of the present disclosure.

FIG. 14 is a schematic diagram of a structure of a target prediction model capable of performing signal prediction or signal performance prediction in a temporal domain provided by an embodiment of the present disclosure.

FIG. 15 is a schematic diagram of performing signal prediction or signal performance prediction in a temporal domain and a spatial domain provided by an embodiment of the present disclosure.

FIG. 16 is a schematic diagram of a structure of a target prediction model capable of performing signal prediction or signal performance prediction in a temporal domain and a spatial domain provided by an embodiment of the present disclosure.

FIG. 17 is a schematic diagram of a relationship between a prediction of a performance a BFD RS and a prediction of an NBI RS provided by an embodiment of the present disclosure.

FIG. 18 is another schematic flowchart of a wireless communication method provided by an embodiment of the present disclosure.

FIG. 19 is another schematic flowchart of a wireless communication method provided by an embodiment of the present disclosure.

FIG. 20 is another schematic flowchart of a wireless communication method provided by an embodiment of the present disclosure.

FIG. 21 is a schematic block diagram of a terminal device provided by an embodiment of the present disclosure.

FIG. 22 is a schematic block diagram of a network device provided by an embodiment of the present disclosure.

FIG. 23 is another schematic block diagram of a network device provided by an embodiment of the present disclosure.

FIG. 24 is another schematic block diagram of a terminal device provided by an embodiment of the present disclosure.

FIG. 25 is a schematic block diagram of a communication device provided by an embodiment of the present disclosure.

FIG. 26 is a schematic block diagram of a chip provided by an embodiment of the present disclosure.

### DETAILED DESCRIPTION

In the embodiments of the present disclosure, the performances of N target signals and/or K target signals whose performances satisfy a preset condition among the N target signals are predicted by using the introduced target prediction model based on the performances of M historical signals. Compared with a method in which the network device configures reference signals dedicated to the measurements of performances of the target signals for the terminal device, it is avoided that the network device configures reference signals dedicated to the measurements of performances of the target signals for the terminal device, the signaling overhead caused when obtaining the performances of the N target signals and/or the K target signals is reduced, and the delay caused when obtaining the performances of the N target signals and/or the K target signals is reduced. In short, according to the solutions provided by the embodiments of the present disclosure, the signaling overhead and delay caused when obtaining the performances of the N target signals and/or the K target signals whose performances satisfy the preset condition among the N target signals can be reduced.

Hereinafter, the technical solutions in the embodiments of the present disclosure will be described with reference to the accompanying drawings in the embodiments of the present disclosure.

It should be noted that the term “predefined” or “preset” in the embodiments of the present disclosure may be realized by storing corresponding codes, tables, or other methods that may be used to indicate relevant information in advance in devices (including, for example, the terminal device and the network device), and specific implementations are not limited in the present disclosure. For example, “preset” may refer to “defined” in the protocol. Alternatively, the “protocol” may refer to a standard protocol in the field of communication, and may include, for example, a Long Term Evolution (LTE) protocol, a New Radio (NR) protocol, and related protocols applied to future communication systems, which are not specifically limited in the present disclosure.

In addition, the term “indication” may be a direct indication, an indirect indication, or represent an associated relationship. For example, A indicates B, which may represent that A directly indicates B, for example, B may be acquired by A. It may also represent that A indicates B indirectly, for example, A indicates C, and B may be acquired through C. It may also represent that there is an association relationship between A and B. The term “correspondence” may represent that there is a direct correspondence or indirect correspondence between the two objects, may represent that there is an associated relationship between the two objects, or may represent a relationship between indicating and being instructed, configuring and being configured, or the like. In addition, the description of “when” in the embodiments of the present disclosure may be interpreted as “if”, “in case” or “in response to”. Similarly, depending on the context, the phrase “if determining” or “if detecting (a stated condition or event)” may be interpreted as “when determining”, “in response to determining”, “when detecting (a stated condition or event)” or “in response to detecting (a stated condition or event)”. It should be noted that the term “predefined” or “predefined rule” may be realized by storing corresponding codes, tables, or other methods that may be used to indicate relevant information in advance in devices (including, for example, the terminal device and the network device), and specific implementations are not limited in the present disclosure. For example, “predefined” may refer to “defined” in the protocol. It should also be understood that in the embodiments of the present disclosure, the “protocol” may refer to a standard protocol in the field of communication, and may include, for example, a LTE protocol, a NR protocol, and related protocols applied to future communication systems, which are not specifically limited in the present disclosure. In addition, in the embodiments of the present disclosure, the term “and/or” is only used for describing an association relationship between associated objects, which indicates that there may be three kinds of relationships. Specifically, A and/or B may represent three cases: A exists alone, A and B exist simultaneously, and B exists alone. In addition, the character “/” in the present disclosure generally represents that there is an “or” relationship between the associated objects.

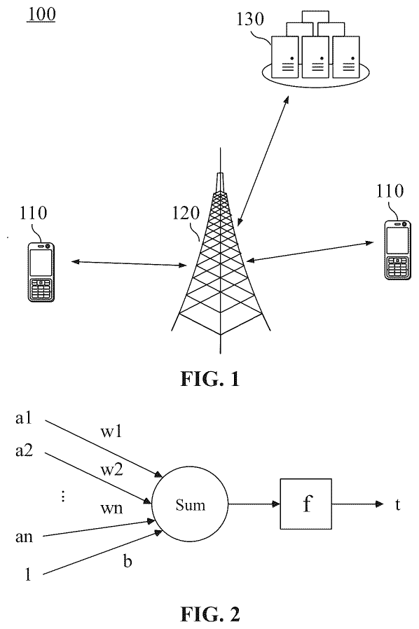

FIG. 1 is an example of a system architecture according to an embodiment of the present disclosure.

As illustrated in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrated with reference to the communication system 100, and the embodiments of the present disclosure are not limited thereto. That is, the technical solutions of the embodiments of the present disclosure may be applied to various communication systems, such as a LTE system, an LTE Time Division Duplex (TDD), a Universal Mobile Telecommunication System (UMTS), an Internet of Things (IoT) system, and a Narrow Band Internet of Things (NB-IoT) system, an enhanced Machine-Type Communications (eMTC) system, a 5G communication system (also referred to as a NR communication system), or a future communication system, etc.

In the communication system 100 illustrated in FIG. 1, the network device 120 may be an access network device that communicates with the terminal device 110. The access network device may provide communication coverage for a particular geographic area and may communicate with terminal devices 110 (for example, User Equipment (UE)) located within that coverage area.

The network device 120 may be an Evolutional Node B (eNB or eNodeB) in a LTE system, a Next Generation Radio Access Network (NG RAN) device, a base station (gNB) in an NR system, a wireless controller in a Cloud Radio Access Network (CRAN), a relay station, an access point, a vehicle-mounted device, a wearable device, a hub, a switch, a bridge, a router, or a network device in a future evolutional Public Land Mobile Network (PLMN), etc.

The terminal device 110 may be any terminal device, which includes, but not limited to, a terminal device that uses a wired or wireless connection to the network device 120 or other terminal devices.

For example, the terminal device 110 may refer to an access terminal, a UE, a subscriber unit, a subscriber station, a mobile station, a mobile stage, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with wireless communication functionality, a computing device or other processing device connected to a wireless modem, a vehicle-mounted device, a wearable device, a terminal device in a 5G network or a terminal device in a future evolution network, or the like.

The terminal device 110 may be used for device-to-device (D2D) communication.

The wireless communication system 100 may further include a core network device 130 that communicates with the base station. The core network device 130 may be a 5G Core (5GC) device, for example, an Access and Mobility Management Function (AMF), for another example, an Authentication Server Function (AUSF), for another example, a User Plane Function (UPF), for another example, Session Management Function (SMF). Alternatively, the core network device 130 may also be an Evolved Packet Core (EPC) device of an LTE network, for example, a Session Management Function+Core Packet Gateway (SMF+PGW-C) device. It should be understood that the SMF+PGW-C may simultaneously implement functions capable of the SMF and the PGW-C. In the process of network evolution, the above core network device may be called by other names, or a new network entity may be formed by dividing functions of the core network, which is not limited by the embodiments of the present disclosure.

A connection may be established between the respective functional units in the communication system 100 through a next generation network (NG) interface to achieve communication.

For example, the terminal device establishes an air interface connection with the access network device through the NR interface for transmitting user plane data and control plane signaling. The terminal device may establish a control plane signaling connection with the AMF through a NG interface 1 (N1). An access network device, such as a next generation radio access base station (gNB), may establish a user plane data connection with the UPF through an NG interface 3 (N3). The access network device may establish a control plane signaling connection with the AMF through a NG interface 2 (N2). The UPF may establish a control plane signaling connection with the SMF through a NG interface 4 (N4). The UPF may interact user plane data with the data network through a NG interface 6 (N6). The AMF may establish a control plane signaling connection with the SMF through a NG interface 11 (N11). The SMF may establish a control plane signaling connection with the PCF through a NG interface 7 (N7).

FIG. 1 exemplarily illustrates one base station, one core network device, and two terminal devices. Alternatively, the wireless communication system 100 may include multiple base station devices, and another number of terminal devices may be included within the coverage area of each base station, which is not limited in the embodiments of the present disclosure.

It should be understood that devices having communication functions in the network/system in the embodiments of the present disclosure may be referred to as communication devices. Taking the communication system 100 illustrated in FIG. 1 as an example, the communication device may include a network device 120 and a terminal device 110 that have a communication function, and the network device 120 and the terminal device 110 may be the devices described above, which will not be repeated here. The communication device may also include other devices in the communication system 100, such as other network entities such as a network controller and a mobility management entity, which are not limited in the embodiments of the present disclosure.

It is to be understood that the terms “system” and “network” are often used interchangeably in the present disclosure. Herein, the term “and/or” is only used for describing an association relationship between associated objects, which represents that there may be the following three relationships. For example, A and/or B may represent that A exists alone, A and B exist simultaneously, and B exists alone. In addition, the character “/” in the present disclosure generally represents that there is an “or” relationship between the associated objects.

In order to facilitate a better understanding of the embodiments of the present disclosure, the contents related to the present disclosure will be described.

1. Neural Network (NN).

The NN model is an operation model composed of multiple neuron nodes connected to each other, in which the connection between nodes represents the weighted value from the input signal to the output signal, which is called weight. Each node performs a weighted summation (SUM) on different input signals, and the result is output through a specific activation function (f).

FIG. 2 is a schematic diagram of a neuron structure provided by an embodiment of the present disclosure.

As illustrated in FIG. 2, a1, a2, . . . , an represent the input signals, w1, w2, . . . , wn represent weights, f represents the activation function, and t represents the output. That is, the nodes perform weighted summation on a1, a2, . . . , an according to w1, w2, . . . , wn, and t is output through a specific activation function (f).

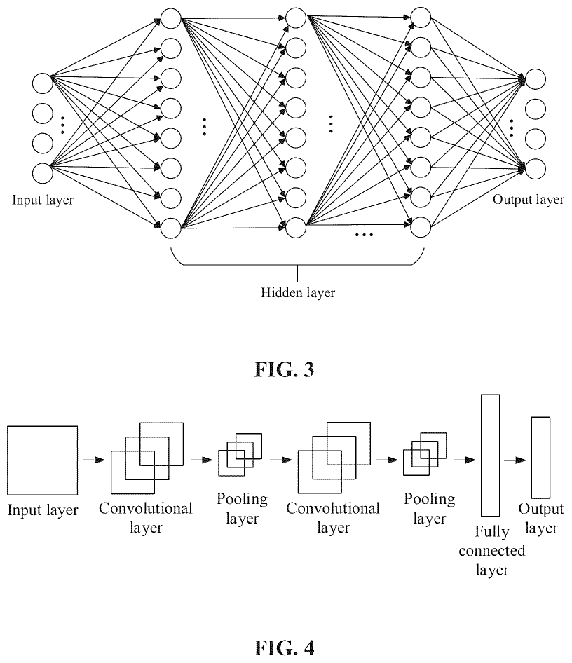

FIG. 3 is an example of a structure of a neural network provided by an embodiment of the present disclosure.

As illustrated in FIG. 3, NN includes an input layer, hidden layers and an output layer. Through different connection methods of multiple neurons, weights and activation functions, different outputs may be generated, and then the mapping relationship from input to output may be fitted. When each upper level node is connected to all one level lower nodes thereof, the NN is a fully connected neural network, which may also be called a Deep Neural Network (DNN). The NN may be used to make correlation prediction of signals or signal performances in the spatial domain.

FIG. 4 is a schematic diagram of a convolutional neural network provided by an embodiment of the present disclosure.

As illustrated in FIG. 4, the basic structures of a CNN include an input layer, multiple convolutional layers, multiple pooling layers, a fully connected layer and an output layer. Each neuron of a convolution kernel in the convolutional layer is locally connected to its input, and the local maximum or average value feature of a certain layer is extracted by introducing pooling layer, which effectively reduces the parameters of the network and mines the local features, so that the convolutional neural network can converge quickly and obtain excellent performance.

Recurrent Neural Network (RNN) is a neural network that models sequence data. It has made remarkable achievements in the field of natural language processing, such as the application of machine translation, speech recognition and so on. Specifically, the network remembers the information of past moment and uses it to calculate the current output, that is, the nodes between the hidden layers are no longer unconnected but connected, and the inputs of the hidden layers include not only the input layer but also the output of the hidden layer at the previous moment. The common RNN includes Long Short-Term Memory (LSTM) networks, gated recurrent units (GRU) and other structures.

FIG. 5 is a schematic diagram of a LSTM unit provided by an embodiment of the present disclosure.

As illustrated in FIG. 5, the basic structures of the LSTM unit may include an activation function (tanh), an input gate (first σ from left to right), a forgetting gate (second σ from left to right), and an output gate (third σ from left to right). When a piece of information enters the LSTM unit, it may be judged whether it is useful or not according to the rule. Only the information that meets the algorithm authentication will be left, and the information that does not meet the algorithm authentication will be forgotten through the forgetting gate. Unlike RNN, which only considers the most recent state, LSTM will decide which states should be left and which states should be forgotten, which solves the shortcomings of the traditional RNN in long-term memory.

2. NN Training.

Through the processes of construction, training, verification and testing for data set, an NN may be trained to be obtained. In the embodiments of the present disclosure, it is assumed that the NN has been trained offline or online in advance. It should be noted that offline training and online training are not mutually exclusive. Firstly, the NW may obtain a static training result through offline training, which may be called offline training. During the use of the NN by the NW or UE, with further measurement and/or reporting by the UE, the NN may continue to collect more data and perform real-time online training to optimize the parameters of the NN to achieve better inference and prediction results.

The following takes the predictions of signals in a spatial domain and their performances as an example to explain how to use supervised (label-based) learning to train the DNN. After having a dataset of labels, the final model parameters may be found by using classical algorithms such as backpropagation (which includes factors such as gradient descent).

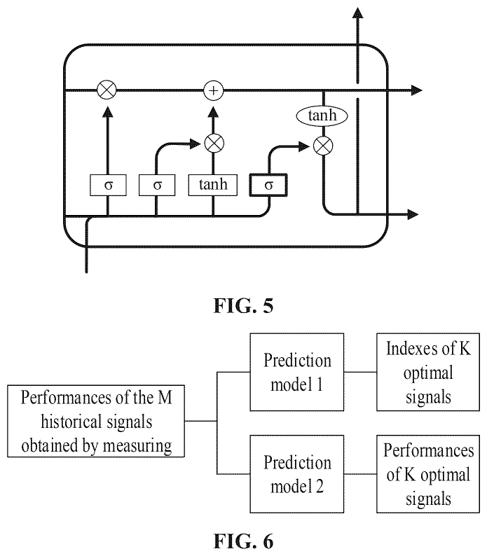

FIG. 6 is a schematic diagram of training and inferring K optimal signals and performances of K optimal signals by using two independent prediction models provided by an embodiment of the present disclosure.

As illustrated in FIG. 6, two independent prediction models may be used to make inferences separately. Specifically, the two prediction models use the same input but have different outputs. The prediction model 1 outputs indexes of K optimal signals, and the prediction model 2 outputs performances of K optimal signals.

Exemplarily, a Data Set for training may include the following portions.

Input: the prediction model 1 and the prediction model 2 use the same input, that is, the performances of the M historical signals obtained by measuring, for example, the Layer 1 Reference Signal Receiving Power (L1-RSRP). The M historical signals may be inputted in a certain order.

Label: for the prediction model 1, its label(s) is the indexes of K optimal signals obtained by measuring in the universal set, and for the prediction model 2, the label(s) is the performances of K optimal signals obtained by measuring in the universal set.

Output: for the prediction model 1, the indexes of K optimal signals are output, and for the prediction model 2, the performances of K optimal signals are output.

It should be noted that if the prediction model 1 outputs K optimal signals, a case of being less than K optimal signals may be inferred through the prediction model 1, but a case of being more than K optimal signals may be not inferred through the prediction model 1, which is limited by the fact that the prediction model 1 has not been trained and it cannot been supported by the model parameters.

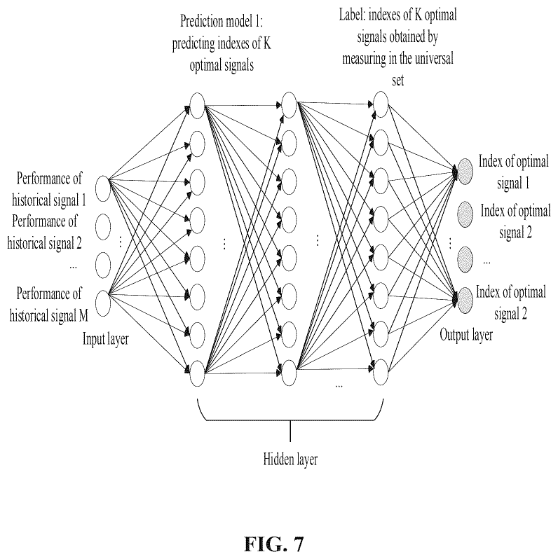

FIG. 7 is a schematic diagram of an input-output relationship of the prediction model 1 provided by an embodiment of the present disclosure.

As illustrated in FIG. 7, a measurement set of M historical signals (a part of signals in the universal set) is used as an input to the prediction model 1. The output is the indexes of K optimal signals, that is, the K optimal signals with the highest performances. The label(s) used by this prediction model 1 is indexes of K optimal signals with optimal performances (for example, the highest L1-RSRP) obtained by measuring in the whole set.

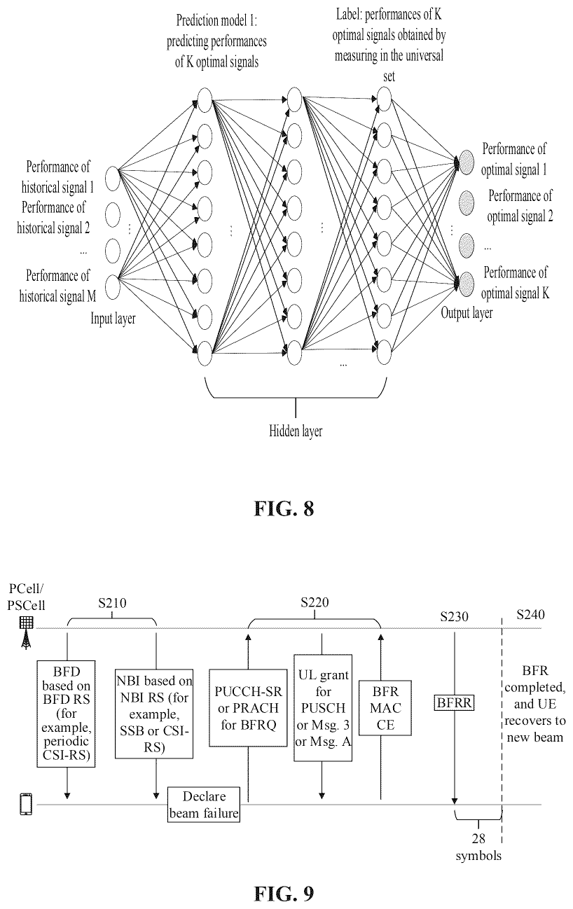

FIG. 8 is a schematic diagram of an input-output relationship of a prediction model 2 provided by an embodiment of the present disclosure.

As illustrated in FIG. 8, the prediction model 2 has the same input with the prediction model 1. Unlike the prediction model 1, the output of prediction model 2 is the performances of K optimal signals. The label(s) is the performances of the K optimal signals obtained by measuring in the universal set.

3. Beam failure recovery (BFR).

In the evolution of 3GPP standard, beam recovery mechanisms in different scenarios are supported. Specifically, a BFR mechanism of a Primary Cell (PCell) or a Primary Secondary Cell (PSCell) is supported in the first version (i.e., Rel.15) of a New Radio (NR), and a beam recovery mechanism of the Secondary Cell (SCell) is supported in Rel. 16. A BFR mechanism dedicated to the TRP is supported in Rel.17.

For a better understanding of the beam recovery mechanism, the following describes the BFR process taking the BFR process of the PCell or the PSCell as an example.

FIG. 9 is a schematic flowchart of a BFR process provided by an embodiment of the present disclosure.

As illustrated in FIG. 9, the BFR process may include the following operations.

In operation S210, a UE performs Beam Failure Detection (BFD) based on a Beam Failure Detection Reference Signal (BFD RS) and a New Beam Identification (NBI) based on a New Beam Identification Reference Signal (NBI RS).

In operation S220, beam failure is reported.

Exemplarily, the UE reports a Beam Failure Recovery reQuest (BFRQ) to a network (NW). When a Beam Failure Event occurs in the serving cell, the UE may use the uplink resource to carry a BFR Media Access Control (MAC) Control Element (CE) to inform the NW of the beam failure situation, and the MAC CE should include an identification (ID) of the serving cell in which the beam failure occurs and a new beam (selected from the NBI RS) suitable for Physical Downlink Control Channel (PDCCH) transmission. The uplink resource may be requested from a PUCCH-Scheduling Request (SR) transmitted by the UE, or may be an uplink Physical Uplink Shared Channel (PUSCH) resource for other purposes. In addition, the BFR MAC CE may be carried in a random access message 3 (Msg.3) or a message A (Msg.A).

In operation S230, the BFR is responded.

Exemplarily, the NW transmits a Beam Failure Recovery Response (BFRR) to the UE. When the NW receives the BFRQ transmitted by the UE, if the beam failure recovery request of the UE is agreed, an acknowledgement should be provided to the UE. The acknowledgement is implemented by Downlink Control Information (DCI). The DCI includes the Hybrid Automatic Repeat Request (HARQ) process ID, that is the same as that used for previously scheduling the PUSCH (carrying the BFR MAC CE), and the reversed New Data Indicator (NDI) field.

In operation S240, 28 symbols after the BFRR is received by the UE, the beams of the PDCCH and the PUCCH of the UE are automatically restored to the new beam.

It should be understood that FIG. 9 is merely an example of the present disclosure, which should not be construed as a limitation of the present disclosure.

For example, the BFR process involved in the embodiments of the present disclosure may be a BFR of a PCell or a BFR of a Scell.

It should be noted that the above BFR process relies on a periodic Channel State Information Reference Signal (CSI-RS), and/or, a Synchronization Signal and/or a physical broadcast channel (PBCH) block (SSB) as a BFD RS to detect a Beam Failure Event, and relies on a periodic CSI-RS and/or SSB as a NBI RS to find a suitable new beam (reported to NW through the BFRQ only in the case of beam failure). Both the BFD RS and the NBI RS are periodic downlink reference signals. In one case, a Radio Resource Control (RRC) configuration displayed by the NW to the UE. Alternatively, UE makes a decision by itself according to a downlink (DL) Reference Signal (RS) included in a Transmission configuration indication (TCI) state of a Control Resource Set (CORESET) in which a Physical Downlink Control Channel (PDCCH) is located. The TCI state is also referred to as beam indication information. In this way, a certain downlink reference signal overhead is caused to the NR system, which leads to the high cost of the BFR process. In addition, due to the characteristics of periodic reference signal itself, it will also bring the delay required to complete multiple periodic measurements, which will lead to excessive delay of BFR process.

In view of this, the present disclosure introduces an Artificial Intelligence (AI) and/or Machine Learning (ML) based prediction model (hereinafter collectively referred to as a target prediction model) to predict signal performance and/or signals satisfying a prediction condition, thereby reducing overhead and delay caused by measuring the reference signals in the temporal domain and/or the spatial domain. In addition, if the Beam Failure Event can be predicted in advance, the occurrence of the Beam Failure Event can be avoided through the mechanism of spatial filter adjustment, thereby improving the overall experience of the UE.

AI is a theory, method, technology and application system that uses digital computers or machines controlled by digital computers to simulate, extend and expand human intelligence, perceive the environment, acquire knowledge and use knowledge to obtain the best results. In other words, AI is a comprehensive technology of computer science, which attempts to understand the essence of intelligence and produce a new intelligent machine that can respond in a way similar to human intelligence. AI is to study the design principles and implementation methods of various intelligent machines to cause machines to have the functions of perception, reasoning and decision-making. It should be understood that AI technology is a comprehensive discipline involving a wide range of fields, including both hardware-level technologies and software-level technologies. Basic technologies of AI generally include technologies such as sensors, dedicated AI chips, cloud computing, distributed storage, big data processing technology, operation/interaction system, mechatronics, etc. AI software technology mainly includes computer vision technology, speech processing technology, natural language processing technology, machine learning/deep learning and other major directions.

ML is a multi-field interdisciplinary subject, involving probability theory, statistics, approximation theory, convex analysis, algorithm complexity theory and other disciplines. It specializes in how computers simulate or realize human learning behaviors, so as to acquire new knowledge or skills, and reorganize the existing knowledge structure to continuously improve their own performance. ML is the core of AI and the fundamental way to make computers intelligent. Its application covers all fields of AI. ML and DL usually include technologies such as artificial neural networks, confidence networks, reinforcement learning, transfer learning, inductive learning, and learning from instruction.

The following describes a wireless communication method provided by an embodiment of the present disclosure in a case where the target prediction model is deployed on the terminal device side.

FIG. 10 is a schematic flowchart of a wireless communication method 310 provided by an embodiment of the present disclosure. The wireless communication method 310 may be performed by a terminal device, for example, may be performed by the terminal device illustrated in FIG. 1.

As illustrated in FIG. 10, the wireless communication method 310 may include the following operations.

In operation S311, the terminal device obtains performances of M historical signals by detecting the M historical signals.

In operation S312, the terminal device predicts performances of N target signals, and/or K target signals whose performances satisfy a preset condition among the N target signals by using a target prediction model based on the performances of the M historical signals.

M and N are both positive integers, and K≤N.

In the embodiments of the present disclosure, the performances of N target signals and/or K target signals whose performances satisfy a preset condition among the N target signals are predicted by using the introduced target prediction model and based on the performances of M historical signals. Compared with a method in which the network device configures reference signals dedicated to the measurements for performances of the target signals for the terminal device, it is avoided that the network device configures reference signals dedicated to the measurements for performances of the target signals for the terminal device, the signaling overhead caused when obtaining the performances of the N target signals and/or the K target signals is reduced, and the delay caused when obtaining the performances of the N target signals and/or the K target signals is reduced is reduced. In short, according to the solutions provided by the embodiments of the present disclosure, the signaling overhead and delay caused when obtaining the performances of the N target signals and/or the K target signals whose performances satisfy the preset condition among the N target signals can be reduced.

Exemplarily, when the target prediction model is used to predict K target signals, the target prediction model may be specifically used to predict indexes of the K target signals.

Exemplarily, the target prediction model may be trained in the manner of training the prediction model 1 as mentioned above. For example, when the target prediction model is used to predict K target signals whose performances satisfy a preset condition among N target signals, the target prediction model may be trained in the manner of training the prediction model 1 as mentioned above.

Exemplarily, the target prediction model may be trained in the manner of training the prediction model 2 as mentioned above. For example, when the target prediction model is used to predict the performances of N target signals, the target prediction model may be trained in the manner of training the prediction model 2 as mentioned above. For another example, when the target prediction model is used to predict K target signals whose performances satisfy a preset condition among N target signals and the performances of the K target signals, the target prediction model may be trained in the manner of training the prediction model 2 as mentioned above.

In some embodiments, the historical signal includes a reference signal and/or a physical channel.

Exemplarily, the historical signal may be an uplink channel or an uplink signal. The uplink channel may include a Physical Random Access Channel (PRACH), a Physical Uplink Control channel (PUCCH), a Physical Uplink Shared channel (PUSCH), and the like. The uplink reference signal may include an uplink Demodulation Reference Signal (DMRS), a Sounding Reference Signal (SRS), a phase tracking reference signal (PT-RS), and the like. The uplink DMRS may be used for demodulation of the uplink channel, the SRS may be used for measurement of the uplink channel, uplink time-frequency synchronization or phase tracking, and the PT-RS may also be used for measurement of the uplink channel, uplink time-frequency synchronization or phase tracking.

Exemplarily, the historical signal may be a downlink channel or a downlink signal. The downlink channel may include a Physical Downlink Control Channel (PDCCH), a Physical Downlink Shared Channel (PDSCH), a Paging Control Channel (PCCH), a Paging Channel (PCH), a Primary Common Control Physical Channel (P-CCPCH), and the like. The downlink reference signal may include a downlink Demodulation Reference Signal (DMRS). The downlink DMRS may be used for demodulation of a downlink channel.

It should be understood that in the embodiments of the present disclosure, an uplink physical channel or an uplink reference signal having the same name and different function as the above uplink physical channel or uplink reference signal may be included, or an uplink physical channel or an uplink reference signal having the different name and the same function as the above uplink physical channel or uplink reference signal may be included, which is not limited in the present disclosure. In addition, it should also be understood that the terms “downlink” and “uplink” referred to in the present disclosure are used to represent the transmission direction of signals or data. The “downlink” is used to represent that the transmission direction of signals or data is the first direction transmitted from the station to the UE of the cell, and the “uplink” is used to represent that the transmission direction of signals or data is the second direction transmitted from the UE of the cell to the station. For example, the “downlink signal” represents that the transmission direction of the signal is the first direction.

In addition, in other alternative embodiments, the terms “historical signal” and “target signal” referred to in the present disclosure may be equivalently replaced with “beam (pair)”, which means “beam” or “beam pair”. Specifically, the “beam” refers to a transmission beam on the downlink NW side, and the “beam pair” refers to a pair of downlink transmission beam (NW side) and a reception beam (UE side). The “beam” may also be referred to as a spatial filter, for example, the transmission beam may be referred to as a Spatial domain transmission filter (or Spatial domain filter for transmission), or the reception beam may be referred to as a Spatial domain reception filter (or Spatial domain filter for reception). Prediction may also be equivalently replaced with inference or other terms having the same or similar meaning.

Exemplarily, the performances of the N target signals and/or K target signals whose performances satisfy a preset condition among the N target signals may be used for the BFR. For example, the performances of the N target signals and/or the K target signals may be used for the BFD and NBI in the BFR. For the BFD, the performances of the N target signals and/or the K target signals may be used to predict the performances of the BFD RSs, thereby predicting whether a Beam Failure Event occurs. For the NBI, the performances of the N target signals and/or the K target signals may be used to predict the NBI RSs that satisfy a preset condition, that is, new beams that may be used for beam recovery.

It should be noted that the prediction of the performances of the BFD RSs and the prediction of the NBI RSs that satisfy the preset condition may be performed through the same prediction model, or may be performed through two independent prediction models, which is not specifically limited in the embodiments of the present disclosure.

As a specific example, the target prediction model involved in the present disclosure may be trained to have two sets of parameters, one set of parameters may be used for predicting the performances of the BFD RSs, and the other set of parameters may be used for predicting the NBI RSs that satisfy a preset condition. As another specific example, the target prediction model involved in the present disclosure may be used only for prediction of the performances of the BFD RSs. In addition, a prediction model independent of the target prediction model and used for prediction of the NBI RSs that satisfy a preset condition may be trained. As yet another example, the target prediction model involved in the present disclosure may be used only for prediction of the NBI RSs that satisfy a preset condition. In addition, a prediction model independent of the target prediction model and used for prediction of the performances of the BFD RSs may be trained.

Of course, in other alternative embodiments, the performances of the N target signals and/or the K target signals may also be used in other scenarios, which is specifically limited in the present disclosure.

In some embodiments, the reference signal includes a Cell-specific reference signal and/or a terminal device-specific (UE-specific) reference signal.

Exemplarily, the Cell-specific reference signal is for a cell, and it is necessary to consider the coverage of the cell. For example, the Cell-specific reference signal may be a reference signal that covers the cell uniformly. For the UE-specific reference signal, it is only necessary to consider the coverage of the terminal device. For example, the UE-specific reference signal may be a reference signal capable of covering the terminal device.

In some embodiments, the M historical signals and the N target signals arc signals associated in the spatial domain.

Exemplarily, the M historical signals correspond to M spatial filters, and the N target signals correspond to N spatial filters. The M spatial filters are a subset of the N spatial filters. Alternatively, the M spatial filters and the N spatial filters are partially different. Alternatively, the M spatial filters and the N spatial filters are different from each other. In other words, there is an association in the spatial domain between the M spatial filters corresponding to the M historical signals and the N spatial filters corresponding to the N target signals.

In some embodiments, the M historical signals and the N target signals are the same signals in the spatial domain.

Exemplarily, the M historical signals correspond to M spatial filters, and the N target signals correspond to N spatial filters. The M spatial filters and the N spatial filters are the same.

Of course, in other alternative embodiments, the M historical signals and the N target signals may be distinguished from other perspectives, which is not specifically limited in the present disclosure. As one example, the M historical signals are a subset of the N target signals. For example, the signal types of the M historical signals are a subset of the signal types of the N target signals. As another example, the M historical signals and the N target signals are partially different. For example, the signal types of the M historical signals and the signal types of the N target signals are partially different. As yet another example, the M historical signals and the N target signals are different from each other. For example, the signal types of the M historical signals and the signal types of the N target signals are different from each other.

In some embodiments, the preset condition may be determined based on an application scenario of the K target signals.

Exemplarily, if the K target signals are used for New Beam Detection (NBD), the preset condition may be being less than or equal to a preset threshold.

Exemplarily, if the K target signals are used for New Beam Identification (NBI), the preset condition may be being greater than or equal to a preset threshold.

In some embodiments, the operation S312 may include the following operation.

The terminal device predicts the performances of the N target signals and/or the K target signals in a spatial domain by using the target prediction model based on the performances of the M historical signals.

Exemplarily, if the M historical signals and the N target signals are signals associated in the spatial domain, the terminal device predicts the performances of the N target signals and/or the K target signals in the spatial domain by using the target prediction model based on the performances of the M historical signals.

In some embodiments, if the performances of the M historical signals include performances of the M historical signals at the first moment, the performances of the N target signals include performances of the N target signals at the first moment, and the K target signals include target signals whose performances satisfy the preset condition at the first moment among the N target signals.

Exemplarily, the terminal device may predict the performances of the N target signals at the first moment by using the target prediction model based on the performances of the M historical signals at the first moment. Alternatively, the terminal device may predict target signals whose performances satisfy the preset condition at the first moment among the N target signals by using the target prediction model based on the performances of the M historical signals at the first moment.

It should be noted that the main basis for the terminal device to predict in the spatial domain based on the M historical signals is that the M historical signals and the N target signals are signals associated in the spatial domain, for example, the M spatial filters and the N spatial filters have a certain association. For example, if the spatial filter directions of the M historical signals and the spatial filter directions of the N target signals are close to each other, when the performances of the M historical signals are good, the performances of the N target signals tend to be good, and vice versa.

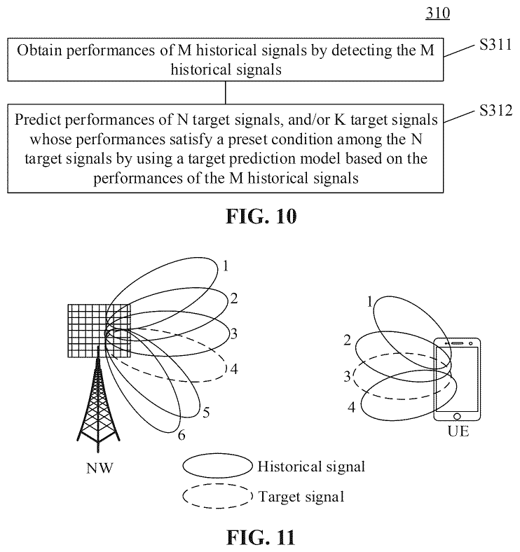

FIG. 11 is a schematic diagram of a relationship between historical signals and target signals provided by an embodiment of the present disclosure.

As illustrated in FIG. 11, it is assumed that the reference signals transmitted by the network device include Cell-specific reference signals and UE-specific reference signals. The Cell-specific reference signals may be a reference signal 1, a reference signal 3, and a reference signal 5, and the reference signal 3 is a reference signal covering the terminal device. The UE-specific reference signals may be the reference signal 2 and the reference signal 6. That is, both the reference signal 2 and the reference signal 6 can cover the terminal device. In this case, the M historical signals involved in the present disclosure may include the reference signal 3 capable of covering the terminal device among the Cell-specific reference signals, or may include the reference signal 2 or the reference signal 6 that are the UE-specific reference signals. It is assumed that the reference signal 4 is the target signal, which means that the historical signals and the target signal are signals associated in the spatial domain, and in this case, the terminal device may predict the performance of the reference signal 4 or predict that the reference signal 4 is a signal that satisfy a preset condition, by using the target prediction model based on the performances of the reference signal 3, the reference signal 2, and the reference signal 6.

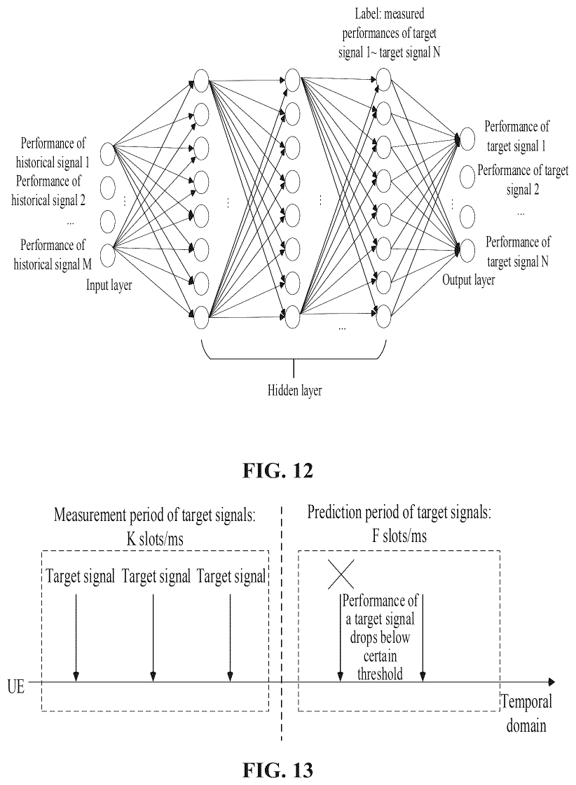

FIG. 12 is a schematic diagram of a structure of a target prediction model capable of performing signal prediction or signal performance prediction in a spatial domain provided by an embodiment of the present disclosure.

As illustrated in FIG. 12, the target prediction model includes an input layer, hidden layers and an output layer. The different outputs may be generated through different connection methods of multiple neurons, weights and activation functions, and then the mapping relationship from input to output may be fitted. When each upper level node is connected to all its lower level nodes, the target prediction model is DNN. The target prediction model may be used to make associated prediction of signals or signal performance in the spatial domain. Specifically, in the prediction process, the inputs of the target prediction model are the performance of the historical signal 1 to the performance of the historical signal M, and the outputs of the target prediction model are the performance of the target signal 1 to the performance of the target signal N. Similarly, in the training process, the inputs of the target prediction model are the performance of the historical signal 1 to the performance of the historical signal M, the outputs of the target prediction model is the performance of the target signal 1 to the performance of the target signal N, and the labels used in the target prediction model are the performance of the target signal 1 to the performance of the target signal N that are obtained by measuring. Based on this, the terminal device may train the target prediction model based on the performance of the target signal 1 to the performance of the target signal N that are obtained by predicting and the performance of the target signal 1 to the performance of the target signal N that are obtained by measuring.

Of course, FIG. 12 is merely an example of the present disclosure, which should not be construed as a limitation of the present disclosure.

For example, in other alternative embodiments, the target prediction model may be used to predict K target signals whose performances satisfy the prediction condition among N target signals.

Specifically, in the prediction process, the inputs of the target prediction model are the performance of the historical signal 1 to the performance of the historical signal M, and the outputs of the target prediction model are the index of the target signal 1 to the index of the target signal K. The performances of target signal 1 to the target signal K satisfy the preset condition. Similarly, in the training process, the inputs of the target prediction model are the performance of the historical signal 1 to the performance of the historical signal M, the output of the target prediction model are the index of the target signal 1 to the index of the target signal K, and the labels used in the target prediction model are the index of the target signal 1 to the index of the target signal K that are obtained by measuring. Based on this, the terminal device may train the target prediction model based on the index of the target signal 1 to the index of the target signal K that are obtained by predicting and the index of the target signal 1 to the index of the target signal K that are obtained by measuring.

In some embodiments, the S312 may include the following operation.

The terminal device predicts the performances of the N target signals and/or the K target signals in a temporal domain by using the target prediction model based on the performances of the M historical signals.

For example, if the M historical signals and the N target signals are the same signals in the spatial domain, the terminal device predicts the performances of the N target signals and/or the K target signals in the temporal domain by using the target prediction model based on the performances of the M historical signals.

In some embodiments, if the performances of the M historical signals include performances of the N target signals within each of E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

Exemplarily, the terminal device may predict the performances of the N target signals within each of the F time units by using the target prediction model based on the performances of the N target signals within each of the E time units.

For example, the terminal device may predict the performance of the first target signal within each of the F time units by using the target prediction model based on the performances of the first target signal among the N target signals within each of the E time units.

Exemplarily, the terminal device may predict target signals whose performances satisfy the preset condition among the N target signals within each of the F time units by using the target prediction model based on the performances of the N target signals in each of the E time units.

For example, the terminal device may predict whether the second target signal is a target signal whose performance satisfies the preset condition within each of the F time units by using the target prediction model based on the performance of the second target signal among the N target signals within each of the E time units.

Exemplarily, the performances of the N target signals within each of the E time units may be sorted in an order of indexes of the N target signals. For example, the performances of the N target signals within each of the E time units may be sorted in descending or ascending order of the indexes of the N target signals.

Of course, in other alternative embodiments, for each of the E time units, the inputs of the target prediction model may be the correspondences between N performances and indexes of the N target signals. For example, the inputs of the target prediction model may be indexes of the M target signals and a performance of each of the N target signals.

Exemplarily, the time unit includes, but is not limited to, a slot, a symbol, a frame, a subframe, or the like.

Exemplarily, the time unit includes millisecond, second, or the like.

Exemplarily, the E time units are E consecutive time units.

Exemplarily, the F time units are F consecutive time units.

Exemplarily, the E time units and the F time units are consecutive or there are intervals between the E time units and the F time units.

Exemplarily, the E time units are time units within a measurement period of the target signals.

Exemplarily, the F time units are time units within a prediction period of the target signals.

FIG. 13 is a schematic diagram of performing signal prediction or signal performance prediction in a temporal domain provided by an embodiment of the present disclosure.

As illustrated in FIG. 13, it is assumed that the E time units are measurement period of the target signals, in this case, the terminal device firstly measures the performances of the target signals in the measurement period of the target signals to obtain the performance within each time unit in the measurement period of the target signals, and then the terminal device predicts the performances of the target signals within each time unit in the prediction period of the target signal based on the performance within each time unit in the measurement period of the target signal. Further, the terminal device may determine that the performances of the target signals predicted within the time units in the prediction period of the target signals are lower than a certain threshold based on the performances of the target signals within each time unit in the prediction period of the target signals.

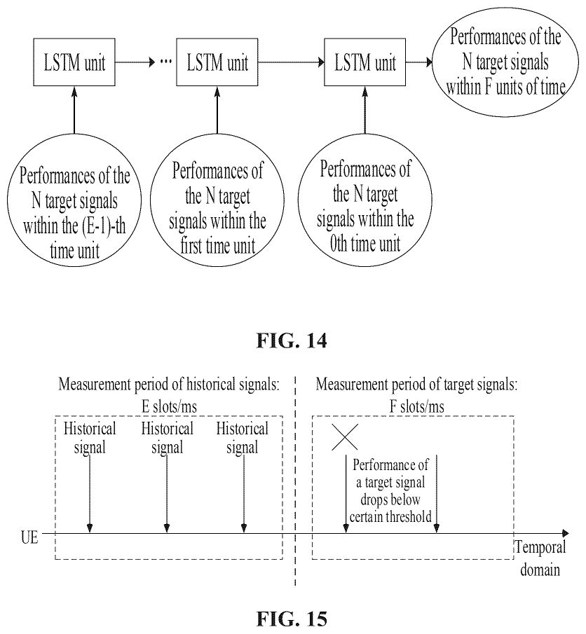

FIG. 14 is a schematic diagram of a structure of a target prediction model capable of performing signal prediction or signal performance prediction in a temporal domain provided by an embodiment of the present disclosure.

As illustrated in FIG. 14, taking the terminal device predicting the performances of the N target signals within each of the F time units based on the performances of the N target signals within each of the E time units by using the target prediction model as an example, the target prediction model includes the E cascaded LSTM units, and the inputs of each LSTM unit are the performances measured within one time unit of the N target signals. It is assumed that the E time units include the (E-1)-th time unit, the (E-2)-th time unit, . . . , the first time unit, and the 0th time unit in the temporal domain, the inputs of the first LSTM unit of the E LSTM units are the performances of the N target signals measured on the (E-1)-th time unit, the inputs of the second LSTM unit are the performances of the N target signals measured on the (E-2)-th time unit, and so on, the inputs of the penultimate LSTM unit are the performances of the N target signals measured on the first time unit, and the inputs of the last LSTM unit are the performances of the N target signals measured on the 0th time unit. The performances of the N target signals within each of the E time units may be sorted according to an order of indexes of the N target signals. Based on this, the outputs of the last LSTM unit are the performances of the N target signals within each of the F time units.

Of course, FIG. 14 is merely an example of the present disclosure, which should not be construed as a limitation of the present disclosure.

For example, in other alternative embodiments, the target prediction model may be used to predict K target signals whose performances satisfy the prediction condition among N target signals.

In some embodiments, the operation S312 may include the following operation.

The terminal device predicts the performances of the N target signals and/or the K target signals in the spatial domain and the temporal domain by using the target prediction model based on the performances of the M historical signals.

Exemplarily, if the M historical signals and the N target signals are associated signals in the spatial domain, the terminal device predicts the performances of the N target signals and/or the K target signals in the spatial domain and the temporal domain by using the target prediction model based on the performances of the M historical signals.

In some embodiments, if the performances of the M historical signals include performances of the M historical signals within each of the E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

Exemplarily, the terminal device may predict the performances of the N target signals within each of the F time units by using the target prediction model based on the performances of the M historical signals within each of the E time units.

For example, the terminal device may predict the performance of the first historical signal within each of the F time units by using the target prediction model based on the performance of the first historical signal among the M historical signals within each of the E time units.

Exemplarily, the terminal device may predict target signals whose performances satisfy the preset condition among the N target signals within each of the F time units by using the target prediction model based on the performances of the M historical signals within each of the E time units.

For example, the terminal device may predict whether the second historical signal is a target signal whose performance satisfies the preset condition within each of the F time units by using the target prediction model based on the performance of the second historical signal among the M historical signals within each of the E time units.

Exemplarily, the performances of the M historical signals within each of the E time units may be sorted in an order of indexes of the M historical signals. For example, the performances of the M historical signals within each of the E time units may be sorted in descending or ascending order of the indexes of the M historical signals.

Of course, in other alternative embodiments, for each of the E time units, the inputs of the target prediction model may be correspondences between the performances of the M historical signals and the indexes of the M historical signals. For example, the inputs of the target prediction model may be indexes of the M historical signals and a performance of each target signal in the N historical signals.

It should be noted that the main basis for the terminal device to predict in the spatial domain and the time domain based on the M historical signals is that the M historical signals and the N target signals are signals associated in the spatial domain, for example, the M spatial filters and the N spatial filters have a certain association. For example, if the spatial filter directions of the M historical signals and the spatial filter directions of the N target signals are close to each other, when the performances of the M historical signals are good, the performances of the N target signals tend to be good in a certain period of time in the future, and vice versa.

Exemplarily, the time unit includes, but is not limited to, a slot, a symbol, a frame, a subframe, or the like.

Exemplarily, the time unit includes millisecond, second, or the like.

Exemplarily, the E time units are E consecutive time units.

Exemplarily, the F time units are F consecutive time units.

Exemplarily, the E time units and the F time units are consecutive or there are intervals between the E time units and the F time units.

Exemplarily, the E time units are time units within a measurement period of the target signals.

Exemplarily, the F time units are time units within a prediction period of the target signals.

In some embodiments, the terminal device may predict the performances of the N target signals within each of F time units in the following two methods.

In the first method, the terminal device predicts the performances of the N target signals within each of the E time units by using the first sub-model in the target prediction model based on the performances of the M historical signals within each of the E time units, and predicts the performances of the N target signals within each of the F time units by using the second sub-model in the target prediction model based on the performances of the N target signals within each of the E time units.

In the second method, the terminal device predicts the performances of the M historical signals within each of the F time units by using the second sub-model in the target prediction model, and predicts the performances of the N target signals within each of the F time units by using the first sub-model in the target prediction model based on the performances of the M historical signals within each of the F time units.

Exemplarily, the first sub-model may be E DNNs corresponding to the E time units.

Exemplarily, the second sub-model may be E cascaded LSTM units corresponding to the E time units.

Exemplarily, the E DNNs and the E LSTM units are connected in a one-to-one correspondence manner.

Exemplarily, for the first method, the performances of the M historical signals within each of the E time units are inputs of one of the E DNNs.

Exemplarily, for the second method, the performances of the M historical signals within each of the E time units are inputs of one of the E LSTM units.

Of course, in other alternative embodiments, the first sub-model and the second sub-model may also be implemented by other models or networks, which are not specifically limited in the present disclosure.

FIG. 15 is a schematic diagram of performing signal prediction or signal performance prediction in a temporal domain and a spatial domain provided by an embodiment of the present disclosure.

As illustrated in FIG. 15, it is assumed that the E time units are measurement period of the historical signals, in this case, the terminal device first measures the performances of the historical signals in the measurement period of the historical signals to obtain the performances within each time unit in the measurement period of the historical signals, and then the terminal device predicts the performances of the target signals within each time unit in the prediction period of the target signals based on the performances within each time unit in the measurement period of the historical signals. Further, the terminal device may determine that the performances of the target signals predicted within the time units in the prediction period of the target signals are lower than a certain threshold based on the performances of the target signals within each time unit in the prediction period of the target signals.

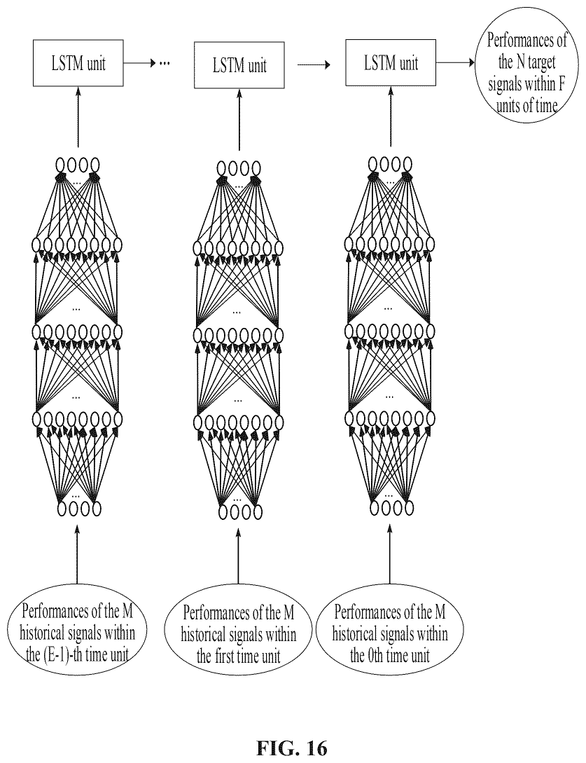

FIG. 16 is a schematic diagram of a structure of a target prediction model capable of performing signal prediction or signal performance prediction in a temporal domain and a spatial domain provided by an embodiment of the present disclosure.

As illustrated in FIG. 16, taking the terminal device predicting the performances of the N target signals within each of F time units based on the performances of the M historical signals within each of E time units by using the target prediction model as an example, the target prediction model includes E cascaded LSTM units and E DNNs. Each LSTM unit connects one DNN. The input of each LSTM unit is the output of the connected RNN, and the inputs of each RNN are the performances measured in one time unit of the M historical signals. It is assumed that the E time units include the (E-1)-th time unit, the (E-2)-th time unit, . . . , the first time unit and the 0th time unit in the temporal domain. The input of the first LSTM unit of E LSTM units is an output obtained by its connected DNN when taking the performances of the M historical signals measured on the (E-1)-th time unit as input, the input of the second LSTM unit is an output obtained by its connected DNN when taking the performances of the M historical signals measured on the (E-2)-th time unit as input, and so on, the input of the penultimate LSTM unit is an output obtained by its connected DNN when taking the performances of the M historical signals measured on the first time unit as input, and the input of the last LSTM unit is an output obtained by its connected DNN when taking the performances of the M historical signals measured on the 0th time unit as input. The performances of the M historical signals within each of the E time units may be sorted in an order of indexes of the M historical signals. Based on this, the outputs of the last LSTM unit are the performances of the N target signals within each of the F time units.

Of course, FIG. 16 is merely an example of the present disclosure, which should not be construed as a limitation of the present disclosure.

For example, in other alternative embodiments, the target prediction model may be used to predict K target signals whose performances satisfy the prediction condition among N target signals.

In some embodiments, the target signal is a BFD RS or a PDCCH.

In the present embodiment, the target signal is designed as a BFD RS or a PDCCH, which is equivalent to perform the beam failure detection in the beam failure recovery mechanism based on AI/ML. That is, the performance prefiction of the BFD RS or the PDCCH in the temporal domain and/or the spatial domain may be directly performed by using a trained target prediction model. On the one hand, the signaling overhead and delay caused when the UE determines the performance of the PDCCH based on the measured performance of the BFD RS can be reduced, and on the other hand, a Beam Failure Event may be predicted in advance through the performance of the BFD RS or PDCCH predicted in the temporal domain (or in the temporal domain and the spatial domain), thereby avoiding the occurrence of the Beam Failure Event to a certain extent.

Exemplarily, the performance of the PDCCH may be judged by the quality of other channels. For example, for a PDSCH that is also in downlink, the UE may inversely infer the Block Error Rate (BLER) of the PDCCH through factors reflecting the performance of the signal, such as SINR or decoding success rate of the PDSCH. Alternatively, the NW may infer the BLER of the PDCCH through factors reflecting performance of the signal, such as SINR or decoding success rate of the PUCCH and/or PUSCH received in the uplink.

Exemplarily, the input of the target prediction model may be a performance of other channels, such as PDSCH/PUCCH/PUSCH or a performance of a signal CSI-RS/SSB/SRS, and the output may be PDCCH BLER. The label used by the target prediction model in the training is the performance of other channel when the beam failure of the PDCCH occurs, such as the error probability or SINR of the PDSCH or the error probability or SINR of the PUCCH/PUSCH. In other words, as long as there is enough data to learn this association, the target prediction model can learn the relationship between the channels that is implicit in the system, thereby completing inference of the BLER of the PDCCH without the measurement of the BFD RS, and thus realizing the prediction of beam failure.

In some embodiments, the method 310 may further include the following operation.

The terminal device determines whether a Beam Failure Event occurs based on the performances of the N target signals and the value of K.

Exemplarily, the N target signals are N BFD RSs.

Exemplarily, the N target signals are N PDCCHs.

In some embodiments, the terminal device determines that the Beam Failure Event occurs if the number of target signals whose performances are less than or equal to the first preset threshold among the N target signals is not 0, or if the value of K is not 0 in a case that the preset condition is that a performance of a target signal is less than or equal to the first preset threshold. Otherwise, the terminal device determines that no Beam Failure Event occurs.

Exemplarily, the N target signals are N BFD RSs, and the terminal device determines that the Beam Failure Event occurs if the number of target signals whose performances are less than or equal to the first preset threshold among the N BFD RSs is not 0, or if the value of K is not 0 in a case that the preset condition is that a performance of a target signal is less than or equal to the first preset threshold. Otherwise, the terminal device determines that no Beam Failure Event occurs.

For example, the N target signals are N PDCCHs, and the terminal device determines that the Beam Failure Event occurs if the number of target signals whose performances are less than or equal to the first preset threshold among the N PDCCHs is not 0, or if the value of K is not 0 in a case that the preset condition is that a performance of a target signal is less than or equal to the first preset threshold. Otherwise, the terminal device determines that no Beam Failure Event occurs.

Exemplarily, the performance of the target signal includes a BLER of the target signal. The BLER of the target signal being greater represents that the performance of the target signal is lower, or the BLER of the target signal being less represents that the performance of the target signal is higher.

It should be noted that when the performance of the target signal includes the BLER of the target signal, the number of target signals whose performances are less than or equal to the first preset threshold among the N target signals is not 0, which may be equivalently replaced with: the number of target signals whose BLERs are greater than or equal to the first preset threshold among the N target signals is not 0. Similarly, when the preset condition is that a performance of a target signal is less than or equal to the first preset threshold, the value of K is not 0, which may be equivalently replaced by: when the preset condition is that the BLER is greater than or equal to the first preset threshold, the value of K is not 0.

For example, it is assumed that the first preset threshold is 10%. In a specific example, the N target signals are N BFD RSs, and the BLERs of the N BFD RSs may be considered to be the BLERs of the PDCCHs corresponding to the N BFD RSs. If the BLERs of the PDCCHs corresponding to the N BFD RSs are greater than 10%, which represents that the BLERs of the PDCCHs corresponding to the N BFD RSs will have a large negative impact on the detection of the PDCCHs, and at this case, the UE may consider that the Beam Failure Event occurs. In another specific example, the N target signals are N PDCCHs, and if the BLERs of the N PDCCHs are greater than 10%, which represents that the BLERs of the N PDCCHs have a large negative impact on the detection of the PDCCHs, and at this case, the UE can consider that the Beam Failure Event occurs.

Exemplarily, the performance of the target signal includes a Layer 1 Reference Signal Receiving Power (L1-RSRP), a Layer 1 Signal to Interference plus Noise Ratio (L1-SINR), or a Layer 1 Reference Signal Receiving Quality (L1-RSRQ). The greater the L1-RSRP, L1-SINR, or L1-RSRQ of the target signal is, the better the performance of the target signal is, or the less the L1-RSRP, L1-SINR, or L1-RSRQ of the target signal is, the worse the performance of the target signal is.

It should be noted that when the performance of the target signal includes L1-RSRP, L1-SINR, or L1-RSRQ of the target signal, the number of target signals whose performances are less than or equal to the first preset threshold among the N target signals is not 0, which may be equivalently replaced with: the number of target signals whose L1-RSRPs, L1-SINRs, or L1-RSRQs are less than or equal to the first preset threshold among the N target signals is not 0. Similarly, when the preset condition is that the performance of the target signal is less than or equal to the first preset threshold, the value of K is not 0, which may be equivalently replaced by: when the preset condition is L1-RSRP, L1-SINR, or L1-RSRQ being less than or equal to the first preset threshold, the value of K is not 0.

In some embodiments, the N target signals are N NBI RSs.

In the present embodiment, the target signal is designed as an NBI RS, which is equivalent to performing NBI in the beam failure recovery mechanism based on AI/ML. That is, the prediction of the performance of the NBI RS in the temporal domain and/or the spatial domain may be directly performed by using the trained target prediction model. On the one hand, the signaling overhead and delay caused when the UE performs the NBI based on the measured performance of the NBI RS can be reduced, and on the other hand, the Beam Failure Event may be predicted in advance through the performance of the NBI RS predicted in the temporal domain (or in the temporal domain and the spatial domain), thereby avoiding the occurrence of the Beam Failure Event to a certain extent.

In some embodiments, the operation S312 may include the following operation.

If a Beam Failure Event occurs, the terminal device predicts the performances of the N target signals and/or the K target signals by using the target prediction model based on the performances of the M historical signals.

Exemplarily, the N target signals are N NBI RSs, and if the Beam Failure Event occurs, the terminal device predicts the performances of the N NBI RSs and/or K target signals satisfying the prediction condition among the N NBI RSs by using the target prediction model based on the performances of the M historical signals.

Considering that prediction in the temporal domain has characteristics on the timeline, when the target prediction model predicts that no the Beam Failure Event is predicted in the next E units of time, or when it is determined that the Beam Failure Event is not be triggered by the detection of the BFD RS, the UE may omit the measurement of the NBI RS or the prediction of the NBI RS to a certain extent, thereby reducing the frequency of the NBI RS prediction through the linkage between the prediction of the BFD RS and the prediction of the NBI RS and reducing the energy consumption of the terminal device.

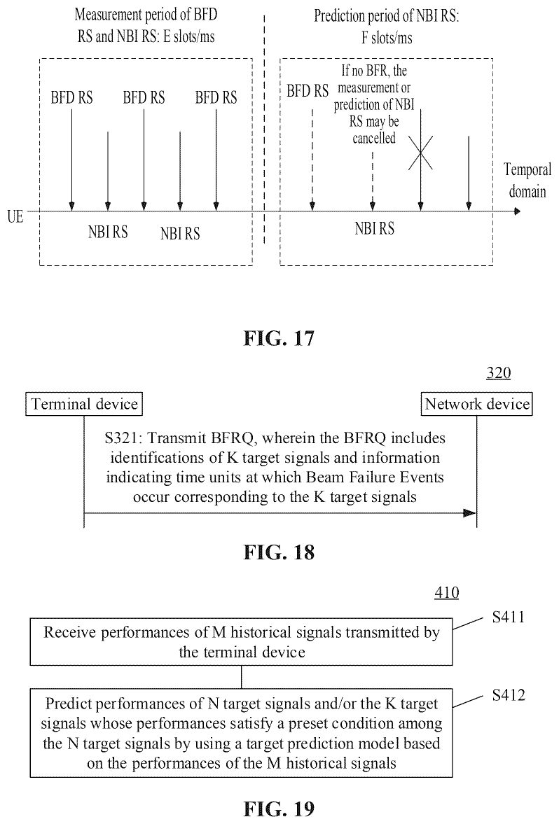

FIG. 17 is a schematic diagram of a relationship between a prediction of a performance a BFD RS and a prediction of an NBI RS provided by an embodiment of the present disclosure.

As illustrated in FIG. 17, the terminal device may measure the BFD RS and the NBI RS, respectively, in the measurement period of the BFD RS and the NBI RS, and predict the performance of the BFD RS in the prediction period based on the measurement performance of the BFD RS in the measurement period. If the performance of the BFD RS within a certain time unit in the prediction period represents that no Beam Failure Event occurs, the subsequent measurement or prediction of the NBI RS may be cancelled.

In some embodiments, the method 310 may further include the following operation.

If the number of target signals whose performances are greater than or equal to a third preset threshold among the N target signals is 0, or if a value of K is 0 in a case that the preset condition is that a performance of a target signal is greater than or equal to the third preset threshold, the terminal device predicts performances of P target signals, and/or the K target signals whose performances satisfy the preset condition among the P target signals by using the target prediction model. The N target signals are a subset of the P target signals.

Exemplarily, the N target signals are N NBI RSs, and if the number of target signals whose performances are greater than or equal to the third preset threshold among the N NBI RSs is 0, or if the value of K is 0 in a case that the preset condition that a performance of a target signal is greater than or equal to the third preset value, the performances of the P NBI RSS and/or the K target signals whose performances satisfy the preset condition among the P NBI RSs are predicted by using the target prediction model. The N NBI RSs are a subset of the P NBI RSs.

In other words, when the prediction result of the target prediction model shows that there is no suitable NBI RS among the N NBI RSs, the target prediction model may expand the search range and predict one suitable NBI RS from the P NBI RSs to complete the subsequent process in beam failure recovery.

In some embodiments, the N target signals are RSs configured by the network device.

Exemplarily, the N target signals are RSs configured by the network device through Radio Resource Control (RRC) signaling, Media Access Control (MAC) Control Element (CE), or Downlink Control Information (DCI).

Exemplarily, the N target signals are reference signals included in a Transmission configuration indication (TCI) state of a Control Resource Set (CORESET) in which the PDCCH used by the terminal device is located.

In some embodiments, the P target signals include all target signals corresponding to a target band.

Exemplarily, the N target signals are RSs configured by the network device through RRC signaling, MAC CE, or DCI.

Exemplarily, the target band is a band used by the terminal device.

In some embodiments, the method 310 may further include the following operation.

A Beam Failure Recovery request, BFRQ, is transmitted to the network device if the number of target signals whose performances are greater than or equal to the third preset threshold among the N target signals is not 0, or if a value of K is not 0 in a case that the preset condition is that a performance of a target signal is greater than or equal to the third preset threshold. The BFRQ includes identifications of the K target signals.

Exemplarily, the N target signals are N NBI RSs, and the terminal device may find a suitable NBI RS by predicting the performance of the NBI RSs and report the suitable NBI RS to the network device, or the terminal device may directly predict the suitable NBI RS by using the target prediction model and report the predicted NBI RS to the network device. If the number of target signals whose performances are greater than or equal to the third preset threshold among the N target signals is not 0, or if the value of K is not 0 in a case that the preset condition is that a performance of the target signal is greater than or equal to the third preset value, the MAC CE carrying the BFRQ is transmitted to the network device.

Exemplarily, the BFRQ includes identifications of the K target signals and an identification (ID) of a serving cell in which a beam failure occurs.

Specifically, after a Beam Failure Event occurs in the serving cell of the UE, the UE may use an uplink resource to carry a BFR MAC CE to inform the NW of the situation of the beam failure, and the MAC CE may include identification(s) (ID(s)) of serving cell(s) in which the beam failure occurs, and a NBI RS that is suitable for transmitting a PDCCH (which is selected from the set of NBI RSs configured by the network device for the terminal device). The uplink resource may be requested from a PUCCH-Scheduling Request (SR) transmitted by the UE, or may be an PUSCH resource for other purposes. Further, the BFR MAC CE may be carried in a random access message 3 (Msg.3) or a message A (Msg.A).

Exemplarily, the identifications of the K target signals may be identifications of signals among the N target signals referred to above.

Exemplarily, the identifications of the K target signals may be identifications of signals among the P target signals referred to above.

Exemplarily, the identification of the K target signals may be indexes of the K target signals.

In some embodiments, the method 310 may further include the following operation.

The terminal device receives the BFRR transmitted by the network device after transmitting Q time units of the BFRR.

Exemplarily, the BFRR is used to confirm that the target signal reported by the terminal device is received by the network device.

Specifically, after the NW receives the BFRQ transmitted by the UE, if the beam failure recovery request of the UE is agreed, an acknowledgement (i.e., the BFRR) should be provided to the UE. The BFRR is implemented by DCI. The DCI includes the HARQ process ID, that is the same as that used for previously scheduling the PUSCH (carrying the BFR MAC CE), and the reversed NDI field.

In some embodiments, the method 310 may further include the following operation.

After receiving Q time units of the BFRR, the terminal device performs data transmission by using spatial filters corresponding to the K target signals. Q is a positive integer.

Exemplarily, the Q time units are time units of 28 symbols or time units of other length.

In some embodiments, the BFRQ further includes information indicating time units at which Beam Failure Events occur corresponding to the K target signals.

Exemplarily, if the target prediction model performs prediction in the temporal domain, or the target prediction model performs prediction in the temporal domain and the spatial domain, the BFRQ further includes information indicating time units at which Beam Failure Events occur corresponding to the K target signals.

Exemplarily, one or more target signals of the K target signals correspond to one time unit at which the Beam Failure Event occurs.

Exemplarily, the information indicating time units at which the Beam Failure Events occur corresponding to the K target signals may be information for indicating positions of the time units at which the Beam Failure Events occur corresponding to the K target signals in the above described F time units, information for indicating positions of the time units at which the Beam Failure Events occur corresponding to the K target signals in the above described measurement period of the target signals, or information for indicating positions of the time units at which the Beam Failure Events occur corresponding to the K target signals in the above described prediction period of the target signals.

In some embodiments, the method 310 may further include the following operation.

The terminal device performs data transmission by using a spatial filter corresponding to the first target signal among the K target signals at a later one of the second moment and the third moment.

The second moment is a moment when the terminal device receives the BFRR, and the third moment is determined according to a time unit at which a Beam Failure Event occurs corresponding to the first target signal.

Exemplarily, the third moment is a starting moment, an end moment, an intermediate moment, or other reference moment of the time unit at which the Beam Failure Event occurs corresponding to the first target signal.

In some embodiments, the performances of the historical signals or the performances of the target signals include at least one of following: L1-RSRP, L1-SINR, L1-RSRQ, and BLER.

Exemplarily, when the target signals are NBD RSs or PDCCHs, the performances of the target signals are BLER.

Exemplarily, when the target signals are NBI RSs, the performances of the target signals are L1-RSRP, L1-SINR, or L1-RSRQ.

In some embodiments, the method 310 may further include the following operation.

The terminal device transmits capability information of the terminal device to a network device.

The capability information includes at least one of following: information for indicating whether the target prediction model is supported; information for indicating whether a prediction in a spatial domain based on the target prediction model is supported; information for indicating whether a prediction in a temporal domain based on the target prediction model is supported; and information of the target prediction model.

Exemplarily, the information of the target prediction model may include type information supported by the target prediction model, description information of the target prediction model, prediction capability of the target prediction model, or the like. Alternatively, the type information includes DNN, LSTM, or other model types. Alternatively, the description information includes the number of input parameters, the number of layers, the number of output parameters, or the like of the target prediction model. Alternatively, the prediction capability includes a type of the target signals that may be predicted by the target prediction model, whether the target prediction model can support performance prediction of the N target signals, whether the target prediction model supports prediction of K target signals satisfying the preset condition, or the like.

In some embodiments, the method 310 may further include the following operation.

The terminal device receives configuration information transmitted by the network device. The configuration information is used to configure the terminal device to use the target prediction model.

Exemplarily, if the terminal device supports the target prediction model, the terminal device receives the configuration information transmitted by the network device after the terminal device transmits the capability information of the terminal device to the network device. After receiving the configuration information, the terminal device performs prediction for signal performance or signal by using the target prediction model.

Exemplarily, the configuration information may further include trained parameters of the target prediction model.

Exemplarily, the configuration information may further include information for indicating that the target prediction model performs a prediction in a temporal domain, a spatial domain, or a spatio-temporal domain. Of course, the configuration information may not include information for indicating that the target prediction model performs a prediction in a temporal domain, a spatial domain, or a spatio-temporal domain, and at this case, the terminal device may determine that the prediction is performed in the temporal domain, the spatial domain, or the spatio-temporal domain, which is not specifically limited in the embodiments of the present disclosure.

Exemplarily, the configuration information is carried in RRC signaling, MAC CE, or DCI transmitted by the network device.

The above text specifically describes the wireless communication method according to the embodiments of the present disclosure when the target prediction model is deployed on the terminal device side from the perspective of the terminal device with reference to FIG. 10 to FIG. 17, and the following text describes the wireless communication method according to the embodiments of the present disclosure from the perspective of the network device with reference to FIG. 18.

FIG. 18 is a schematic flowchart of a wireless communication method 320 provided by an embodiment of the present disclosure. The wireless communication method 320 may be interactively performed by a terminal device and a network device. The terminal device illustrated in FIG. 18 may be the terminal device illustrated in FIG. 1, and the network device illustrated in FIG. 18 may be the access network device illustrated in FIG. 1.

As illustrated in FIG. 18, the method 320 may include the following operation.

In operation S321, a network device receives a Beam Failure Recovery request, BFRQ, transmitted by a terminal device.

The BFRQ includes identifications of K target signals and information indicating time units at which Beam Failure Events occur corresponding to the K target signals.

Exemplarily, the BFRQ includes identifications of the K target signals and an ID of a serving cell in which a beam failure occurs.

Specifically, after a Beam Failure Event occurs in the serving cell of the UE, the UE may use an uplink resource to carry a BFR MAC CE to inform the NW of the beam failure situation, and the MAC CE may include an ID of the serving cell in which the beam failure occurs and a NBI RS (selected from the NBI RS set configured by the network device for the terminal device) suitable for PDCCH transmission. The uplink resource may be requested from a PUCCH-SR transmitted by the UE, or may be an uplink PUSCH resource for other purposes. In addition, the BFR MAC CE may be carried in a random access message 3 (Msg.3) or a message A (Msg.A)

Exemplarily, the identifications of the K target signals may be identifications of signals among the N target signals referred to above.

Exemplarily, the identifications of the K target signals may be identifications of signals among the P target signals referred to above.

Exemplarily, the identification of the K target signals may be indexes of the K target signals.

In some embodiments, the method 320 may further include the following operation.

After transmitting Q time units of the BFRR, the network device transmits the BFRR to the terminal device.

Exemplarily, the BFRR is used to confirm that the target signal reported by the terminal device is received by the network device.

Specifically, when the NW receives the BFRQ transmitted by the UE, if the beam failure recovery request of the UE is agreed, an acknowledgement (i.e., the BFRR) is needs to be provided to the UE. The BFRR is implemented by DCI. The DCI includes the HARQ process ID, that is the same as that used for previously scheduling the PUSCH (carrying the BFR MAC CE), and the reversed NDI field.

In some embodiments, the method 320 may further include the following operation.

Data transmission is performed by using a spatial filter corresponding to the first target signal among the K target signals at a later one of the second moment and the third moment.

The second moment is a moment when the terminal device receives the BFRR, and the third moment is determined according to a time unit at which a Beam Failure Event occurs corresponding to the first target signal.

Exemplarily, the third moment is a starting moment, an end moment, an intermediate moment, or other reference moment of the time unit at which the Beam Failure Event occurs corresponding to the first target signal.

In some embodiments, the method 320 may further include the following operation.

Capability information transmitted by the terminal device is received.

The capability information includes at least one of following: information for indicating whether the target prediction model is supported; information for indicating whether a prediction in a spatial domain based on the target prediction model is supported; information for indicating whether a prediction in a temporal domain based on the target prediction model is supported; and information of the target prediction model.

Exemplarily, the information of the target prediction model may include type information supported by the target prediction model, description information of the target prediction model, prediction capability of the target prediction model, or the like. Alternatively, the type information includes DNN, LSTM, or other model types. Alternatively, the description information includes the number of input parameters, the number of layers, the number of output parameters, or the like of the target prediction model. Alternatively, the prediction capability includes a type of the target signals that may be predicted by the target prediction model, whether the target prediction model can support performance prediction of the N target signals, whether the target prediction model supports prediction of K target signals satisfying the preset condition, or the like.

In some embodiments, the method 320 may further include the following operation.

Configuration information is transmitted to the terminal device. The configuration information is used to configure the terminal device to use the target prediction model.

Exemplarily, when the network device determines that the terminal device supports the target prediction model based on the received capability information, the network device may transmit the configuration information to the terminal device. After receiving the configuration information, the terminal device performs prediction for signal performance or signal by using the target prediction model.

Exemplarily, the configuration information may further include trained parameters of the target prediction model.

Exemplarily, the configuration information may further include information for indicating that the target prediction model performs a prediction in a temporal domain, a spatial domain, or a spatio-temporal domain. Of course, the configuration information may not include information for indicating that the target prediction model performs a prediction in a temporal domain, a spatial domain, or a spatio-temporal domain, and at this case, the terminal device may determine that the prediction is performed in the temporal domain, the spatial domain, or the spatio-temporal domain, which is not specifically limited in the embodiments of the present disclosure.

Exemplarily, the configuration information is carried in RRC signaling, MAC CE, or DCI transmitted by the network device.

It should be understood that the operations in the wireless communication method 320 may refer to corresponding operations in the wireless communication method 310, which will not be repeated herein for the sake of brevity.

The following describes a wireless communication method according to an embodiment of the present disclosure in a case where the target prediction model is deployed on the network device side.

It should be noted that, regardless of whether the target prediction model is deployed on the terminal device side or the network device side, the specific implementation method for predicting the performances of the N target signals and/or the K target signals whose performances satisfy the preset condition among the N target signals is not affected, and the difference is mainly that if the target prediction model is deployed on the network device side, the terminal device needs to report the performances of the M historical signals obtained by measuring to the network device, so that the network device uses the target prediction model to predict the performances of the N target signals and/or the K target signals whose performances satisfy the preset condition among the N target signals by taking the performances of the M historical signals reported by the terminal device as inputs. In view of the above, a specific implementation method in which the network device uses the target prediction model to perform signal performance prediction and/or signal prediction may refers to related contents in which the terminal device uses the target prediction model to perform signal performance prediction and/or signal prediction, which will not be repeated herein for the sake of brevity.

FIG. 19 is a schematic flowchart of a wireless communication method 410 provided by an embodiment of the present disclosure. The wireless communication method 410 may be performed by a network device, for example, may be performed by the network device illustrated in FIG. 1.

As illustrated in FIG. 19, the wireless communication method 410 may include the following operations.

In operation S411, performances of M historical signals transmitted by the terminal device are received.

In operation S412, performances of N target signals and/or the K target signals whose performances satisfy a preset condition among the N target signals are predicted by using a target prediction model based on the performances of the M historical signals.

M and N are both positive integers, and K≤N.

Exemplarily, the network device may receive the performances of M historical signals reported by the terminal device through MAC CE or Uplink Control Information (UCI).

In some embodiments, the S412 may include the follow operation.

The performances of the N target signals, and/or the K target signals are predicted in a spatial domain by using the target prediction model based on the performances of the M historical signals.

In some embodiments, if the performances of the M historical signals include performances of the M historical signals at a first moment, the performances of the N target signals include performances of the N target signals at the first moment, and the K target signals include target signals whose performances satisfy the preset condition at the first moment among the N target signals.

In some embodiments, the S412 may include the following operation.

The performances of the N target signals, and/or the K target signals are predicted in a temporal domain by using the target prediction model based on the performances of the M historical signals.

In some embodiments, if the performances of the M historical signals include performances of the N target signals within each of E time units, the performances of the N target signals include performances of the N target signals within each of F time units, and the K target signals include target signals whose performances satisfy the preset condition among the N target signals within each of the F time units.

The F time units are located later than E time units, and E and F are both positive integers.

In some embodiments, the S412 may include the following operation.

The performances of the N target signals, and/or the K target signals are predicted in a spatial domain and a temporal domain by using the target prediction model based on the performances of the M historical signals.

In some embodiments, if the performances of the M historical signals include performances of the M historical signals within each of E time units, the performances of the N target signals include performances of the N target signals within each of F time units, and the K target signals include target signals whose performances satisfy the preset condition among the N target signals within each of the F time units.

The F time units are located later than E time units, and E and F are both positive integers.

In some embodiments, predicting the performances of the N target signals within each of the F time units by using the target prediction model based on the performances of the M historical signals within each of the E time units may be implemented through the following methods.

Performances of the N target signals within each of the E time units are predicted by using the first sub-model in the target prediction model based on the performances of the M historical signals within each of the E time units, and the performances of the N target signals within each of the F time units are predicted by using the second sub-model in the target prediction model based on the performances of the N target signals within each of the E time units.

Alternatively, performances of the M historical signals within each of the F time units are predicted by using the second sub-model in the target prediction model based on the performances of the M historical signals within each of the E time units, and the performances of the N target signals within each of the F time units are predicted by using the first sub-model in the target prediction model based on the performances of the M historical signals within each of the F time units.

In some embodiments, the M historical signals correspond to M spatial filters and the N target signals correspond to N spatial filters. The M spatial filters are a subset of the N spatial filters, or the M spatial filters and the N spatial filters are partially different, or the M spatial filters and the N spatial filters are different from each other.

In some embodiments, the historical signals include reference signal and/or physical channel.

In some embodiments, the reference signal includes Cell-specific reference signal and/or terminal device-specific reference signal.

In some embodiments, the target signals are BFD RS or PDCCH.

In some embodiments, the method 410 may further include the following operation.

Whether a Beam Failure Event occurs is determined based on the performances of the N target signals and a value of K.

In some embodiments, it is determined that the Beam Failure Event occurs if the number of target signals whose performances are less than or equal to a first preset threshold among the N target signals is not 0, or if the value of K is not 0 in a case that the preset condition is that a performance of a target signal is less than or equal to the first preset threshold. Otherwise, it is determined that no Beam Failure Event occurs.

In some embodiments, the N target signals are N NBI RSs.

In some embodiments, the operation S412 may include the following operation.

If a Beam Failure Event occurs, the performances of the N target signals, and/or the K target signals are predicted by using the target prediction model based on the performances of the M historical signals.

In some embodiments, the method 410 may further include the following operation.

If the number of target signals whose performances are greater than or equal to the third preset threshold among the N target signals is 0, or if a value of K is 0 in a case that the preset condition is that a performance of a target signal is greater than or equal to the third preset threshold, performances of P target signals, and/or the K target signals whose performances satisfy the preset condition among the P target signals are predicted by using the target prediction model. The N target signals are a subset of the P target signals.

In some embodiments, the N target signals are RSs configured by the network device to the terminal device.

In some embodiments, the P target signals include all target signals corresponding to a target band.

In some embodiments, the method 410 may further include the following operation.

Indication information is transmitted to the terminal device if the number of target signals whose performances are greater than or equal to the third preset threshold among the N target signals is not 0, or if a value of K is not 0 in a case that the preset condition is that a performance of a target signal is greater than or equal to the third preset threshold. The indication information includes identifications of the K target signals.

It should be noted that when the target prediction model is deployed on the terminal device side, if the target signal is a BFD RS or an NBI RS, the BFD RS or the NBI RS is predicted by the terminal device. At this case, after predicting an appropriate NBI RS, the predicted appropriate NBI RS needs to be reported to the network device through the BFRQ, and the network device feeds back the BFRR to the terminal device after receiving the BFRQ, so as to complete beam failure recovery or avoid transmitting the Beam Failure Event.

However, when the target prediction model is deployed on the network device side, if the target signal is a BFD RS or an NBI RS, the prediction of BFD RS or NBI RS is performed by the network device. Under this setting, the terminal device does not need to report the BFRQ, that is, after the Beam Failure Event is predicted (inferred) by the target prediction model, the appropriate NBI RS predicted by the network device is indicated to the terminal device through the indication information, thereby completing the beam failure recovery or avoiding transmitting the Beam Failure Event. Exemplarily, the network device may transmit the indication information to the terminal device through MAC or MAC+DCI.

In some embodiments, the method 410 may further include the following operation.

After transmitting Q time units of the indication information, data transmission is performed by using spatial filters corresponding to the K target signals.

Q is a positive integer.

In some embodiments, the indication information further includes information indicating time units at which Beam Failure Events occur corresponding to the K target signals.

In some embodiments, the method 410 may further include the following operation.

Data transmission is performed by using a spatial filter corresponding to the first target signal among the K target signals at a later one of the second moment and the third moment.

The second moment is a moment when the indication information is transmitted, and the third moment is determined according to a time unit at which a Beam Failure Event occurs corresponding to the first target signal.

In some embodiments, the performances of the historical signals or the performances of the target signals include at least one of following: L1-RSRP, L1-SINR, L1-RSRQ, and BLER.

In some embodiments, the method 410 may further include the following operation.

Capability information transmitted by the terminal device is received.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

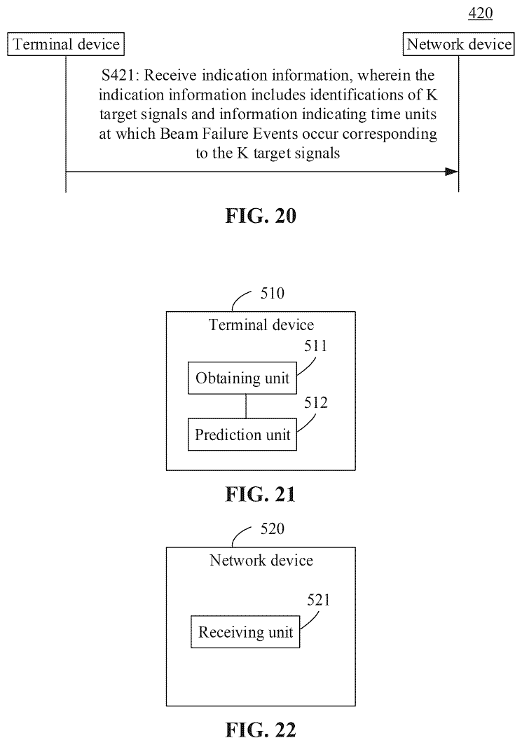

The above text specifically describes the wireless communication method according to the embodiment of the present disclosure when the target prediction model is deployed on the network device side from the perspective of the network device with reference to FIG. 19. The following text describes the wireless communication method according to the embodiment of the present disclosure from the perspective of the terminal device with reference to FIG. 20.

FIG. 20 is a schematic flowchart of a wireless communication method 420 provided by an embodiment of the present disclosure. The wireless communication method 420 may be interactively performed by a terminal device and a network device. The terminal device illustrated in FIG. 20 may be the terminal device illustrated in FIG. 1, and the network device illustrated in FIG. 20 may be the access network device illustrated in FIG. 1.

As illustrated in FIG. 20, the method 420 may include the following operation.

In operation S421, indication information transmitted by a network device is received.

The indication information includes identifications of K target signals and information indicating time units at which Beam Failure Events occur corresponding to the K target signals.

In some embodiments, the method 420 may further include the following operation.

Data transmission is performed by using a spatial filter corresponding to the first target signal among the K target signals at a later one of the second moment and the third moment.

The second moment is a moment when the terminal device receives the indication information, and the third moment is determined according to a time unit at which a Beam Failure Event occurs corresponding to the first target signal.

In some embodiments, the method 420 may further include the following operation.

Capability information of the terminal device is transmitted to the network device.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

In some embodiments, the method 420 may further include the following operation.

Performances of M historical signals are transmitted to the network device.

In some embodiments, the performances of the historical signals or the performances of the target signals include at least one of following: L1-RSRP, L1-SINR, L1-RSRQ, and BLER.

It should be understood that the operations in the wireless communication method 420 may refer to corresponding operations in the wireless communication method 410, which will not be repeated herein for the sake of brevity.

The preferred embodiments of the present disclosure have been described in detail above with reference to the accompanying drawings, but the present disclosure is not limited to the specific details in the above embodiments. Within the scope of the technical concept of the present disclosure, a variety of simple modifications can be made to the technical solutions of the present disclosure, and these simple modifications all belong to the scope of protection of the present disclosure. For example, various specific technical features described in the above detailed embodiments can be combined in any suitable manner without contradiction, and various possible combinations will not be described separately in the present disclosure in order to avoid unnecessary repetition. For example, various embodiments of the present disclosure may be combined arbitrarily, and as long as they do not contradict the idea of the present disclosure, they should be regarded as the disclosure content of the present disclosure as well.

It should also be understood that in various method embodiments of the present disclosure, the size of the sequence numbers of the above processes does not mean the sequence of execution, and the sequence of execution of each process should be determined by its function and internal logic, and should not constitute any limitation on the implementation of the embodiments of the present disclosure. In addition, in the embodiments of the present disclosure, the terms “downlink” and “uplink” are used to indicate the transmission direction of signals or data. The “downlink” is used to indicate that the transmission direction of signals or data is the first direction transmitted from the station to the UE of the cell, and “uplink” is used to indicate that the transmission direction of signals or data is the second direction transmitted from the UE of the cell to the station. For example, the “downlink signal” indicates that the transmission direction of the signal is the first direction. In addition, in the embodiments of the present disclosure, the term “and/or” is only used for describing an association relationship between associated objects, which indicates that there may be three kinds of relationships. Specifically, A and/or B may represent three cases: A exists alone, A and B exist simultaneously, and B exists alone. In addition, the character “/” in the present disclosure generally represents that there is an “or” relationship between the associated objects

The above text specifically describes embodiments of the methods of the present disclosure with reference to FIG. 1 to FIG. 20. The following text specifically describes embodiments of the apparatus of the present disclosure with reference to FIG. 21 to FIG. 26.

FIG. 21 is a schematic block diagram of a terminal device 510 provided by an embodiment of the present disclosure.

As illustrated in FIG. 21, the terminal device 510 may include an obtaining unit 511 and a prediction unit 512.

The obtaining unit 511 is configured to obtain performances of M historical signals by detecting the M historical signals.

The prediction unit 512 is configured to predict, based on the performances of the M historical signals, performances of N target signals, and/or K target signals whose performances satisfy a preset condition among the N target signals by using a target prediction model.

M and N are both positive integers, and K≤N.

In some embodiments, the prediction unit 512 is specifically configured to predict in a spatial domain, based on the performances of the M historical signals, the performances of the N target signals, and/or the K target signals by using the target prediction model.

In some embodiments, if the performances of the M historical signals include performances of the M historical signals at a first moment, the performances of the N target signals include performances of the N target signals at the first moment, and the K target signals include target signals whose performances satisfy the preset condition at the first moment among the N target signals.

In some embodiments, the prediction unit 512 is specifically configured to predict in a temporal domain, based on the performances of the M historical signals, the performances of the N target signals, and/or the K target signals by using the target prediction model.

In some embodiments, if the performances of the M historical signals include performances of the N target signals within each of E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

In some embodiments, the prediction unit 512 is specifically configured to predict in a spatial domain and a temporal domain, based on the performances of the M historical signals, the performances of the N target signals, and/or the K target signals by using the target prediction model.

In some embodiments, if the performances of the M historical signals include performances of the M historical signals within each of E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

In some embodiments, the prediction unit 512 is specifically configured to predict, based on the performances of the M historical signals within each of the E time units, performances of the N target signals within each of the E time units by using a first sub-model in the target prediction model, and predict, based on the performances of the N target signals within each of the E time units, the performances of the N target signals within each of the F time units by using a second sub-model in the target prediction model.

Alternatively, the prediction unit 512 is specifically configured to predict, based on the performances of the M historical signals within each of the E time units, performances of the M historical signals within each of the F time units by using the second sub-model in the target prediction model, and predict, based on the performances of the M historical signals within each of the F time units, the performances of the N target signals within each of the F time units by using the first sub-model in the target prediction model.

In some embodiments, the M historical signals correspond to M spatial filters and the N target signals correspond to N spatial filters. The M spatial filters are a subset of the N spatial filters, or the M spatial filters and the N spatial filters are partially different, or the M spatial filters and the N spatial filters are different from each other.

In some embodiments, the target signals are BFD RS or PDCCH.

In some embodiments, the prediction unit 512 is further configured to determine, based on the performances of the N target signals and a value of K, whether a Beam Failure Event occurs.

In some embodiments, the prediction unit 512 is specifically configured to determine that the Beam Failure Event occurs if the number of target signals whose performances are less than or equal to the first preset threshold among the N target signals is not 0, or if the value of K is not 0 in a case that the preset condition is that a performance of a target signal is less than or equal to the first preset threshold, otherwise, determine that no Beam Failure Event occurs.

In some embodiments, the N target signals are N NBI RSs.

In some embodiments, the prediction unit 512 is specifically configured to, if a Beam Failure Event occurs, predict, based on the performances of the M historical signals, the performances of the N target signals, and/or the K target signals by using the target prediction model.

In some embodiments, the prediction unit 512 is further configured to, if the number of target signals whose performances are greater than or equal to the third preset threshold among the N target signals is 0, or if a value of K is 0 in a case that the preset condition is that a performance of a target signal is greater than or equal to the third preset threshold, predict performances of P target signals, and/or the K target signals whose performances satisfy the preset condition among the P target signals by using the target prediction model. The N target signals are a subset of the P target signals.

In some embodiments, the N target signals are RSs configured by a network device.

In some embodiments, the P target signals include all target signals corresponding to a target band.

In some embodiments, the prediction unit 512 is further configured to transmit a Beam Failure Recovery request, BFRQ, to a network device if the number of target signals whose performances are greater than or equal to the third preset threshold among the N target signals is not 0, or if a value of K is not 0 in a case that the preset condition is that a performance of a target signal is greater than or equal to the third preset threshold.

The BFRQ includes identifications of the K target signals.

In some embodiments, the prediction unit 512 is further configured to after receiving Q time units of the BFRR, perform data transmission by using spatial filters corresponding to the K target signals.

Q is a positive integer.

In some embodiments, the BFRQ further includes information indicating time units at which Beam Failure Events occur corresponding to the K target signals.

In some embodiments, the prediction unit 512 is further configured to perform data transmission by using a spatial filter corresponding to the first target signal among the K target signals at a later one of the second moment and the third moment.

The second moment is a moment when the terminal device receives the BFRR, and the third moment is determined according to a time unit at which a Beam Failure Event occurs corresponding to the first target signal.

In some embodiments, the performances of the historical signals or the performances of the target signals include at least one of following: L1-RSRP, L1-SINR, L1-RSRQ, and BLER.

In some embodiments, the prediction unit 512 is further configured to transmit capability information of the terminal device to a network device.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

In some embodiments, the prediction unit 512 is further configured to receive configuration information transmitted by a network device. The configuration information is used to configure the terminal device to use the target prediction model.

It should be understood that apparatus embodiments and method embodiments may correspond to each other, and similar descriptions may be made with reference to method embodiments. Specifically, the terminal device 510 illustrated in FIG. 21 may correspond to the corresponding entity in the method 310 in the embodiment of the present disclosure. The above and other operations and/or functions of various units in the terminal device 510 are used to respectively implement the corresponding flows in the method 310 provided by the embodiment of the present disclosure, which will not be repeated herein for the sake of brevity.

FIG. 22 is a schematic block diagram of a network device 520 provided by an embodiment of the present disclosure.

As illustrated in FIG. 22, the network device 520 may include a receiving unit 521.

The receiving unit 521 is configured to receive a Beam Failure Recovery request, BFRQ, transmitted by a terminal device.

The BFRQ includes identifications of K target signals and information indicating time units at which Beam Failure Events occur corresponding to the K target signals.

In some embodiments, the receiving unit 521 is further configured to perform data transmission by using a spatial filter corresponding to the first target signal among the K target signals at a later one of the second moment and the third moment.

The second moment is a moment when the terminal device receives the BFRR, and the third moment is determined according to a time unit at which a Beam Failure Event occurs corresponding to the first target signal.

In some embodiments, the receiving unit 521 is further configured to receive capability information transmitted by the terminal device.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

In some embodiments, the receiving unit 521 is further configured to transmit configuration information to the terminal device. The configuration information is used to configure the terminal device to use the target prediction model.

It should be understood that apparatus embodiments and method embodiments may correspond to each other, and similar descriptions may be made with reference to method embodiments. Specifically, the network device 520 illustrated in FIG. 22 may correspond to a corresponding entity in the method 320 in the embodiment of the present disclosure. The above and other operations and/or functions of various units in the network device 520 are used to respectively implement the corresponding flows in the method 320 provided by the embodiment of the present disclosure, which will not be repeated herein for the sake of brevity.

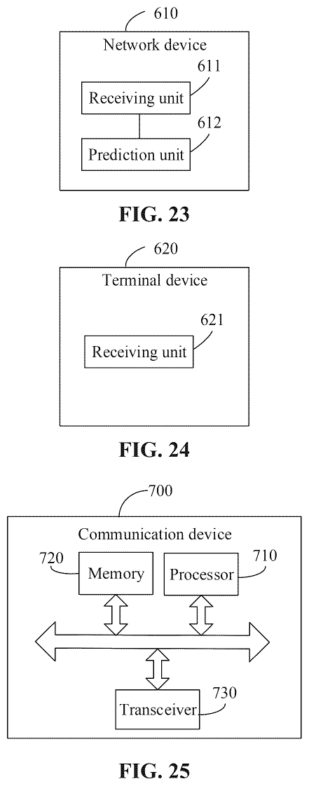

FIG. 23 is a schematic block diagram of a network device 610 provided by an embodiment of the present disclosure.

As illustrated in FIG. 23, the network device 610 may include a receiving unit 611 and a prediction unit 612.

The receiving unit 611 is configured to receive performances of M historical signals transmitted by a terminal device.

The prediction unit 612 is configured to predict, based on the performances of the M historical signals, performances of N target signals, and/or K target signals whose performances satisfy a preset condition among the N target signals by using a target prediction model.

M and N are both positive integers, and K≤N.

In some embodiments, the prediction unit 612 is specifically configured to predict in a spatial domain, based on the performances of the M historical signals, the performances of the N target signals, and/or the K target signals by using the target prediction model.

In some embodiments, if the performances of the M historical signals include performances of the M historical signals at the first moment, the performances of the N target signals include performances of the N target signals at the first moment, and the K target signals include target signals whose performances satisfy the preset condition at the first moment among the N target signals.

In some embodiments, the prediction unit 612 is specifically configured to predict in a temporal domain, based on the performances of the M historical signals, the performances of the N target signals, and/or the K target signals by using the target prediction model.

In some embodiments, if the performances of the M historical signals include performances of the N target signals within each of E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

In some embodiments, the prediction unit 612 is specifically configured to predict in a spatial domain and a temporal domain, based on the performances of the M historical signals, the performances of the N target signals, and/or the K target signals by using the target prediction model.

In some embodiments, if the performances of the M historical signals include performances of the M historical signals within each of E time units, the performances of the N target signals include performances of the N target signals within each of F time units, and the K target signals include target signals whose performances satisfy the preset condition among the N target signals within each of the F time units.

The F time units are later than the E time units, and E and F are both positive integers.

In some embodiments, the prediction unit 612 is specifically configured to predict, based on the performances of the M historical signals within each of the E time units, performances of the N target signals within each of the E time units by using a first sub-model in the target prediction model, and predict, based on the performances of the N target signals within each of the E time units, the performances of the N target signals within each of the F time units by using a second sub-model in the target prediction model.

Alternatively, the prediction unit 612 is specifically configured to predict, based on the performances of the M historical signals within each of the E time units, performances of the M historical signals within each of the F time units by using the second sub-model in the target prediction model, and predict, based on the performances of the M historical signals within each of the F time units, the performances of the N target signals within each of the F time units by using the first sub-model in the target prediction model.

In some embodiments, the M historical signals correspond to M spatial filters and the N target signals correspond to N spatial filters. The M spatial filters are a subset of the N spatial filters, or the M spatial filters and the N spatial filters are partially different, or the M spatial filters and the N spatial filters are different from each other.

In some embodiments, the historical signals include reference signal and/or physical channel.

In some embodiments, the reference signal includes Cell-specific reference signal and/or terminal device-specific reference signal.

In some embodiments, the target signals are BFD RS or PDCCH.

In some embodiments, the prediction unit 612 is further configured to determine, based on the performances of the N target signals and a value of K, whether a Beam Failure Event occurs.

In some embodiments, the prediction unit 612 is specifically configured to determine that the Beam Failure Event occurs if the number of target signals whose performances are less than or equal to the first preset threshold among the N target signals is not 0, or if the value of K is not 0 in a case that the preset condition is that a performance of a target signal is less than or equal to the first preset threshold, otherwise, determine that no Beam Failure Event occurs.

In some embodiments, the N target signals are N NBI RSs.

In some embodiments, the prediction unit 612 is specifically configured to, if a Beam Failure Event occurs, predict, based on the performances of the M historical signals, the performances of the N target signals, and/or the K target signals by using the target prediction model.

In some embodiments, the prediction unit 612 is further configured to, if the number of target signals whose performances are greater than or equal to the third preset threshold among the N target signals is 0, or if a value of K is 0 in a case that the preset condition is that a performance of a target signal is greater than or equal to the third preset threshold, predict performances of P target signals, and/or the K target signals whose performances satisfy the preset condition among the P target signals by using the target prediction model. The N target signals are a subset of the P target signals.

In some embodiments, the N target signals are RSs configured by the network device to the terminal device.

In some embodiments, the P target signals include all target signals corresponding to a target band.

In some embodiments, the prediction unit 612 is further configured to transmit indication information to the terminal device if the number of target signals whose performances are greater than or equal to the third preset threshold among the N target signals is not 0, or if a value of K is not 0 in a case that the preset condition is that a performance of a target signal is greater than or equal to the third preset threshold. The indication information includes identifications of the K target signals.

In some embodiments, the prediction unit 612 is further configured to, after transmitting Q time units of the indication information, perform data transmission by using spatial filters corresponding to the K target signals.

Q is a positive integer.

In some embodiments, the indication information further includes information indicating time units at which Beam Failure Events occur corresponding to the K target signals.

In some embodiments, the prediction unit 612 is further configured to perform data transmission by using a spatial filter corresponding to the first target signal among the K target signals at a later one of the second moment and the third moment.

The second moment is a moment when the indication information is transmitted, and the third moment is determined according to a time unit at which a Beam Failure Event occurs corresponding to the first target signal.

In some embodiments, the performances of the historical signals or the performances of the target signals include at least one of following: L1-RSRP, L1-SINR, L1-RSRQ, and BLER.

In some embodiments, the prediction unit 612 is further configured to receive capability information transmitted by the terminal device.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

It should be understood that device embodiments and method embodiments may correspond to each other, and similar descriptions may be made with reference to method embodiments. Specifically, the network device 610 illustrated in FIG. 23 may correspond to a corresponding entity in the method 410 in the embodiment of the present disclosure. The above and other operations and/or functions of various units in the network device 610 are used to respectively implement the corresponding flows in the method 410 provided by the embodiment of the present disclosure, which will not be repeated herein for the sake of brevity.

FIG. 24 is a schematic block diagram of a terminal device 620 provided by an embodiment of the present disclosure.

As illustrated in FIG. 24, the terminal device 620 may include a receiving unit 621.

The receiving unit 621 is configured to receive indication information transmitted by a network device.

The indication information includes identifications of K target signals and information indicating time units at which Beam Failure Events occur corresponding to the K target signals.

In some embodiments, the receiving unit 621 is further configured to perform data transmission by using a spatial filter corresponding to the first target signal among the K target signals at a later one of the second moment and the third moment.

The second moment is a moment when the terminal device receives the indication information, and the third moment is determined according to a time unit at which a Beam Failure Event occurs corresponding to the first target signal.

In some embodiments, the receiving unit 621 is further configured to transmit capability information of the terminal device to the network device.

The capability information includes at least one of following: information for indicating whether the target prediction model is supported, information for indicating whether a prediction in a spatial domain based on the target prediction model is supported, information for indicating whether a prediction in a temporal domain based on the target prediction model is supported, and information of the target prediction model.

In some embodiments, the receiving unit 621 is further configured to transmit performances of M historical signals to the network device.

In some embodiments, the performances of the historical signals or the performances of the target signals include at least one of following: L1-RSRP, L1-SINR, L1-RSRQ, and BLER.

It should be understood that device embodiments and method embodiments may correspond to each other, and similar descriptions may be made with reference to method embodiments. Specifically, the terminal device 620 illustrated in FIG. 24 may correspond to the corresponding entity in the method 420 in the embodiment of the present disclosure. The above and other operations and/or functions of various units in the terminal device 620 are used to respectively implement the corresponding flows in the method 420 provided by the embodiment of the present disclosure, which will not be repeated herein for the sake of brevity.

The above text describes the communication devices in the embodiments of the present disclosure from the perspective of functional modules with reference to the accompanying drawings. It should be understood that the functional modules may be implemented in hardware form, may be implemented in software form instructions, or may be implemented in combination of hardware and software modules. Specifically, various operations of the method embodiments in the embodiments of the present disclosure may be completed by an integrated logic circuit of hardware in the processor and/or an instruction in the form of software. The operations of the methods disclosed in combination with the embodiments of the present disclosure may be directly embodied as execution by the hardware decoding processor, or may be executed by a combination of hardware and software modules in the decoding processor. Alternatively, the software module may be located in a Random Access Memory (RAM), a flash memory, a Read-Only Memory (ROM), a Programmable ROM (PROM), an electrically erasable PROM (EEPROM), a register and other storage medium mature in the art. The storage medium is located in the memory, and the processor reads the information in the memory and completes the operations of the methods in combination with its hardware.

For example, the processing unit and the communication unit referred to above may be implemented by a processor and a transceiver, respectively.

FIG. 25 is a schematic diagram of a structure of a communication device 700 provided by an embodiment of the present disclosure.

As illustrated in FIG. 25, the communication device 700 may include a processor 710.

The processor 710 may invoke and run a computer program from a memory to implement the methods in the embodiments of the present disclosure.

As illustrated in FIG. 25, the communication device 700 may further include a memory 720.

The memory 720 may be used to store instruction information, and may also be used to store code, instructions, and the like executed by the processor 710. The processor 710 may invoke and run a computer program from the memory 720 to implement the methods in the embodiments of the present disclosure. The memory 720 may be a separate device separate from the processor 710 or may be integrated in the processor 710.

As illustrated in FIG. 25, the communication device 700 may further include a transceiver 730.

The processor 710 may control the transceiver 730 to communicate with other devices, specifically, may transmit information or data to other devices, or receive information or data transmitted by other devices. The transceiver 730 may include a transmitter and a receiver. The transceiver 730 may further include one or more antennas.

It should be understood that the various components in the communication device 700 are connected by a bus system. The bus system includes a power bus, a control bus, and a state signal bus in addition to a data bus.

It should also be understood that the communication device 700 may be the terminal device in the embodiments of the present disclosure, and the communication device 700 may implement the corresponding flows implemented by the terminal device in various methods of the embodiments of the present disclosure. That is, the communication device 700 in the embodiment of the present disclosure may correspond to the terminal device 510 or the terminal device 620 in the embodiments of the present disclosure, and may correspond to the corresponding entity for performing the method 310 or 420 in the embodiments of the present disclosure, which will not be repeated herein for the sake of brevity. Similarly, the communication device 700 may be a network device in the embodiments of the present disclosure, and the communication device 700 may implement corresponding flows implemented by the network device in various methods of the embodiments of the present disclosure. That is, the communication device 700 in the embodiment of the present disclosure may correspond to the network device 520 or the network device 610 in the embodiment of the present disclosure, and may correspond to the corresponding entity for performing the method 320 or 410 in the embodiments of the present disclosure, which will not be repeated herein for the sake of brevity.

In addition, an embodiment of the present disclosure also provides a chip.

For example, the chip may be an integrated circuit chip having signal processing capabilities, and may implement or execute the methods, operations, and logic block diagrams disclosed in the embodiments of the present disclosure. The chip may be a system level chip, a system chip, a chip system or a system-on-chip or the like. Alternatively, the chip may be applied to various communication devices, so that the communication device mounted with the chip can execute the methods, operations, and logic block diagrams disclosed in the embodiments of the present disclosure.

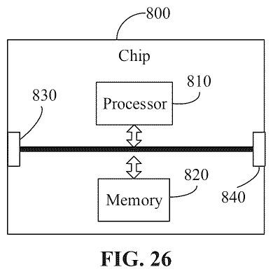

FIG. 26 is a schematic diagram of a structure of a chip 800 provided by an embodiment of the present disclosure.

As illustrated in FIG. 26, the chip 800 includes a processor 810.

The processor 810 may invoke and run a computer program from the memory to implement the methods in the embodiments of the present disclosure.

As illustrated in FIG. 26, the chip 800 may further include a memory 820.

The processor 810 may invoke and run a computer program from the memory 820 to implement the methods in the embodiments of the present disclosure. The memory 820 may be used to store instruction information, and may also be used to store code, instructions, and the like executed by the processor 810. The memory 820 may be a separate device separate from the processor 810 or may be integrated in the processor 810.

As illustrated in FIG. 26, the chip 800 may further include an input interface 830.

The processor 810 may control the input interface 830 to communicate with other devices or chips, specifically, may obtain information or data transmitted by other devices or chips.

As illustrated in FIG. 26, the chip 800 may further include an output interface 840.

The processor 810 may control the output interface 840 to communicate with other devices or chips, specifically, may output information or data to other devices or chips.

It should be understood that the chip 800 may be applied to the network device in the embodiments of the present disclosure, and the chip may implement the corresponding flows implemented by the network device in various methods of the embodiments of the present disclosure, and may also implement the corresponding flows implemented by the terminal device in various methods of the embodiments of the present disclosure, which will not be repeated here for the sake of brevity.

It should also be understood that the various components in the chip 800 are connected by a bus system. The bus system includes a power bus, a control bus, and a status signal bus in addition to a data bus.

The processors referred to above may include, but are not limited to a general purpose processor, a Digital Signal Processor (DSP), an Application Specific Integrated Circuit (ASIC), a Field Programmable Gate Array (FPGA) or other programmable logic device, a discrete gate or transistor logic device, a discrete hardware component, and the like.

The processor may be used to implement or execute the methods, operations, and logic block diagrams disclosed in the embodiments of the present disclosure. The operations of the methods disclosed in combination with the embodiments of the present disclosure may be directly embodied as execution by the hardware decoding processor, or may be executed by a combination of hardware and software modules in the decoding processor. The software module may be located in a RAM, a flash memory, a ROM, a PROM, an EEPROM, a register and other storage medium mature in the art. The storage medium is located in the memory, and the processor reads the information in the memory and completes the operations of the above methods in combination with its hardware.

The memories referred to above include, but are not limited to, volatile memory and/or non-volatile memory. The non-volatile memory may be a ROM, a PROM, an Erasable PROM (EPROM), an EEPROM, or a flash memory. The volatile memory may be a RAM, which serves as an external cache. By way of illustration, but not limitation, many forms of RAM are available, such as static RAM (SRAM), dynamic RAM (DRAM), synchronous DRAM (SDRAM), double data rate SDRAM (DDR SDRAM), Enhanced SDRAM (ESDRAM), a synch link DRAM (SLDRAM) and a Direct Rambus RAM (DR RAM).

It should be noted that the memory described herein is intended to include these and any other suitable types of memory.

The embodiment of the present disclosure also provides a computer readable storage medium for storing a computer program. The computer readable storage medium stores one or more programs including instructions that, when executed by a portable electronic device including multiple application programs, enable the portable electronic device to perform the wireless communication method provided in the present disclosure. Alternatively, the computer readable storage medium may be applied to the network device in the embodiments of the present disclosure, and the computer program causes the computer to execute the corresponding flows implemented by the network device in various methods in the embodiments of the present disclosure, which will not be repeated here for the sake of brevity. Alternatively, the computer readable storage medium may be applied to the mobile terminal/terminal device in the embodiments of the present disclosure, and the computer program causes the computer to execute the corresponding flows implemented by the mobile terminal/terminal device in various methods of the embodiments of the present disclosure, which will not be repeated herein for the sake of brevity.

The embodiment of the present disclosure also provides a computer program product including a computer program. Alternatively, the computer program product may be applied to the network device in the embodiments of the present disclosure, and the computer program causes the computer to execute the corresponding flows implemented by the network device in various methods in the embodiments of the present disclosure, which will not be repeated here for the sake of brevity. Alternatively, the computer program product may be applied to the mobile terminal/terminal device in the embodiments of the present disclosure, and the computer program causes the computer to execute the corresponding flows implemented by the mobile terminal/terminal device in various methods of the embodiments of the present disclosure, which will not be repeated here for the sake of brevity.

The embodiment of the present disclosure also provides a computer program. When the computer program is executed by the computer, the computer may execute the wireless communication method provided in the present disclosure. Alternatively, the computer program may be applied to the network device in the embodiments of the present disclosure, and when the computer program is run on the computer, the computer executes the corresponding flows implemented by the network device in various methods of the embodiments of the present disclosure, which will not be repeated herein for the sake of brevity. Alternatively, the computer program may be applied to the mobile terminal/terminal device in the embodiments of the present disclosure, and when the computer program is run on the computer, the computer executes the corresponding flows implemented by the mobile terminal/terminal device in various methods of the embodiments of the present disclosure, will not be repeated herein for the sake of brevity.

The embodiment of the present disclosure also provides a communication system. The communication system may include the above terminal device and the network device to form the communication system 100 as illustrated in FIG. 1, which will not be repeated herein for the sake of brevity. The term “system” and the like herein may also be referred to as “network management architecture”, “network system” and the like.

It should also be understood that the terms used in the embodiments of the present disclosure and the appended claims are for the purpose of describing particular embodiments only, and are not intended to limit the embodiments of the present disclosure. For example, the singular forms “a”, “the”, and “above” as used in the embodiments of the present disclosure and the appended claims are also intended to include the plurality of forms unless the context clearly indicates otherwise.

Those skilled in the art may appreciate that the elements and algorithmic operations of the various examples described in combination with the embodiments disclosed herein may be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the embodiments of the present disclosure. If implemented in the form of a software functional unit and sold or used as a stand-alone product, it may be stored in a computer readable storage medium. Based on this understanding, the technical solutions of the embodiments of the present disclosure essentially or a part that contributes to the prior art or a part of the technical solutions may be embodied in the form of a software product. The computer software product is stored in a storage medium, which includes several instructions for causing a computer device (which may be a personal computer, a server, or a network device, etc.) to perform all or part of the operations of the methods described in the embodiments of the present disclosure. The storage medium includes various mediums capable of storing program codes, such as a U disk, a removable hard disk, a ROM, a RAM, a magnetic disk, or an optical disk.

Those skilled in the art may appreciate that for convenience and conciseness of the description, the specific working processes of the systems, apparatus, and units described above may refer to the corresponding processes in the above method embodiments, which will not be repeated herein. In several embodiments provided in the present disclosure, it should be understood that the disclosed systems, apparatus, and methods may be implemented in other ways. For example, the division of units, modules or components in the apparatus embodiments described above is only a logical function division, and there may be other division methods in actual implementation, for example, multiple units, modules or components may be combined or integrated into another system, or some units, modules or components may be ignored or not executed. As another example, the units/modules/components described above as separate/display components may or may not be physically separate, that is, they may be located in one place, or may be distributed over multiple network units. Some or all of the units/modules/components may be selected according to actual needs to implement the purpose of the embodiments of the present disclosure. Finally, it should be noted that the coupling, direct coupling or communication connection between each other shown or discussed above may be indirect coupling or communication connection through some interface, device or unit, which may be electrical, mechanical or otherwise.

The above contents are merely specific embodiments of the present disclosure, but the scope of protection of the embodiments of the present disclosure is not limited thereto. Any person skilled in the art may easily think of changes or substitutions within the technical scope disclosed in the embodiments of the present disclosure, which should be covered within the scope of protection of the embodiments of the present disclosure. Therefore, the scope of protection of the embodiments of the present disclosure should be based on the scope of protection of the claims.

1. A wireless communication method, applicable to a terminal device, comprising:
obtaining performances of M historical signals by detecting the M historical signals; and
predicting, based on the performances of the M historical signals, performances of N target signals, and/or K target signals whose performances satisfy a preset condition among the N target signals by using a target prediction model,
wherein M and N are both positive integers, and K≤N.

2. The method of claim 1, wherein predicting, based on the performances of the M historical signals, the performances of the N target signals, and/or the K target signals whose the performances satisfy the preset condition among the N target signals by using the target prediction model comprises:
predicting, in a spatial domain, the performances of the N target signals, and/or the K target signals by using the target prediction model, based on the performances of the M historical signals.

3. The method of claim 1, wherein when the performances of the M historical signals comprise performances of the M historical signals at a first moment,
the performances of the N target signals comprise performances of the N target signals at the first moment, and
the K target signals comprise target signals whose performances satisfy the preset condition at the first moment among the N target signals.

4. The method of claim 1, wherein predicting, based on the performances of the M historical signals, the performances of the N target signals, and/or the K target signals whose the performances satisfy the preset condition among the N target signals by using the target prediction model comprises:
predicting, in a temporal domain, the performances of the N target signals, and/or the K target signals by using the target prediction model, based on the performances of the M historical signals.

5. The method of claim 1, wherein when the performances of the M historical signals comprise performances of the N target signals within each of E time units,
the performances of the N target signals comprise performances of the N target signals within each of F time units, and
the K target signals comprise target signals whose performances satisfy the preset condition among the N target signals within each of the F time units,
wherein the F time units are later than the E time units, and E and F are both positive integers.

6. The method of claim 1, wherein predicting, based on the performances of the M historical signals, the performances of the N target signals, and/or the K target signals whose the performances satisfy the preset condition among the N target signals by using the target prediction model comprises:
predicting, in a spatial domain and a temporal domain, the performances of the N target signals, and/or the K target signals by using the target prediction model, based on the performances of the M historical signals.

7. The method of claim 1, wherein when the performances of the M historical signals comprise performances of the M historical signals within each of E time units,
the performances of the N target signals comprise performances of the N target signals within each of F time units, and
the K target signals comprise target signals whose performances satisfy the preset condition among the N target signals within each of the F time units,
wherein the F time units are later than the E time units, and E and F are both positive integers,
wherein predicting, based on the performances of the M historical signals within each of the E time units, the performances of the N target signals within each of the F time units by using the target prediction model comprises:
predicting, based on the performances of the M historical signals within each of the E time units, performances of the N target signals within each of the E time units by using a first sub-model in the target prediction model, and predicting, based on the performances of the N target signals within each of the E time units, the performances of the N target signals within each of the F time units by using a second sub-model in the target prediction model; or
predicting, based on the performances of the M historical signals within each of the E time units, performances of the M historical signals within each of the F time units by using the second sub-model in the target prediction model, and predicting, based on the performances of the M historical signals within each of the F time units, the performances of the N target signals within each of the F time units by using the first sub-model in the target prediction model.

8. The method of claim 2, wherein the M historical signals correspond to M spatial filters and the N target signals correspond to N spatial filters, and
the M spatial filters are a subset of the N spatial filters, or the M spatial filters and the N spatial filters are partially different, or the M spatial filters and the N spatial filters are different from each other.

9. A terminal device, comprising:
a transceiver, a processor and a memory, wherein the memory is configured to store a computer program, and the processor is configured to invoke and run the computer program stored in the memory to cause the processor and the transceiver to perform:
obtaining performances of M historical signals by detecting the M historical signals; and
predicting, based on the performances of the M historical signals, performances of N target signals, and/or K target signals whose performances satisfy a preset condition among the N target signals by using a target prediction model,
wherein M and N are both positive integers, and K≤N.

10. The terminal device of claim 9, wherein the historical signals comprise reference signal and/or physical channel, wherein the reference signal comprises Cell-specific reference signal and/or terminal device-specific reference signal.

11. The terminal device of claim 9, wherein the target signals are Beam Failure Detection Reference Signal (BFD RS) or Physical Downlink Control Channel (PDCCH).

12. The terminal device of claim 10, wherein the processor is further configured to invoke and run the computer program stored in the memory to cause the processor and the transceiver to perform:
determining, based on the performances of the N target signals and a value of K, whether a Beam Failure Event occurs,
wherein determining, based on the performances of the N target signals and the value of K, whether the Beam Failure Event occurs comprises:
determining that the Beam Failure Event occurs when a number of target signals whose performances are less than or equal to a first preset threshold among the N target signals is not 0, or when the value of K is not 0 in a case that the preset condition is that a performance of a target signal is less than or equal to the first preset threshold, otherwise, determining that no Beam Failure Event occurs.

13. The terminal device of claim 9, wherein the N target signals are N New Beam Identification Reference Signals (NBI RSs).

14. The terminal device of claim 13, wherein the processor is further configured to invoke and run the computer program stored in the memory to cause the processor and the transceiver to perform:
transmitting a Beam Failure Recovery reQuest (BFRQ) to a network device when a number of target signals whose performances are greater than or equal to a third preset threshold among the N target signals is not 0, or when a value of K is not 0 in a case that the preset condition is that a performance of a target signal is greater than or equal to the third preset threshold,
wherein the BFRQ comprises identifications of the K target signals.

15. The terminal device of claim 14, wherein the processor is further configured to invoke and run the computer program stored in the memory to cause the processor and the transceiver to perform:
after receiving Q time units of a Beam Failure Recovery Response (BFRR), performing data transmission by using spatial filters corresponding to the K target signals,
wherein Q is a positive integer.

16. The terminal device of claim 14, wherein the BFRQ further comprises information indicating time units at which Beam Failure Events occur corresponding to the K target signals,
wherein the processor is further configured to invoke and run the computer program stored in the memory to cause the processor and the transceiver to perform:
performing data transmission, at a later one of a second moment and a third moment, by using a spatial filter corresponding to a first target signal among the K target signals,
wherein the second moment is a moment when the terminal device receives the BFRR, and the third moment is determined according to a time unit at which a Beam Failure Event occurs corresponding to the first target signal.

17. The terminal device of claim 9, wherein the performances of the historical signals or the performances of the target signals comprise at least one of: Layer 1 Reference Signal Receiving Power (L1-RSRP), Layer 1 Signal to Interference plus Noise Ratio (L1-SINR), Layer 1 Reference Signal Receiving Quality (L1-RSRQ), and block error rate (BLER).

18. The terminal device of claim 9, wherein the processor is further configured to invoke and run the computer program stored in the memory to cause the processor and the transceiver to perform:
transmitting capability information of the terminal device to a network device,
wherein the capability information comprises at least one of:
information for indicating whether the target prediction model is supported;
information for indicating whether a prediction in a spatial domain based on the target prediction model is supported;
information for indicating whether a prediction in a temporal domain based on the target prediction model is supported; or
information of the target prediction model.

19. A network device, comprising:
a transceiver, a processor and a memory, wherein the memory is configured to store a computer program, and the processor is configured to invoke and run the computer program stored in the memory to cause the processor and the transceiver to perform:
receiving performances of M historical signals transmitted by a terminal device; and
predicting, based on the performances of the M historical signals, performances of N target signals, and/or K target signals whose performances satisfy a preset condition among the N target signals by using a target prediction model,
wherein M and N are both positive integers, and K≤N.

20. The network device of claim 19, wherein the processor is further configured to invoke and run the computer program stored in the memory to cause the processor and the transceiver to perform:
predicting, in a spatial domain, the performances of the N target signals, and/or the K target signals by using the target prediction model, based on the performances of the M historical signals.
